(19) United States
(12) Patent Application Publication
(10) Pub. No.: US 2013/0235927 A1
(43) Pub. Date: Sep. 12, 2013

(54) METHODS AND APPARATUSES FOR ENCODING AND DECODING VIDEO

(71) Applicant: PANASONIC CORPORATION, Osaka (JP)

(72) Inventors: Kyaw Kyaw WIN, Singapore (SG); Chong Soon LIM, Singapore (SG); Sue Mon Thet NAING, Singapore (SG); Hai Wei SUN, Singapore (SG); Viktor WAHADANIAH, Singapore (SG); Toshiyasu SUGIO, Osaka (JP); Takahiro NISHI, Nara (JP); Hisao SASAI, Osaka (JP); Youji SHIBAHARA, Osaka (JP); Kyoko TANIKAWA, Osaka (JP); Toru MATSUNOBU, Osaka (JP); Kengo TERADA, Osaka (JP)

(73) Assignee: PANASONIC CORPORATION, Osaka (JP)

(21) Appl. No.: 13/785,639

(22) Filed: Mar. 5, 2013

Related U.S. Application Data
(60) Provisional application No. 61/608,292, filed on Mar. 8, 2012.

(51) Int. Cl. H04N 7/26

(52) U.S. Cl. CPC H04N 19/00212
USPC 375/240.02

(57) ABSTRACT

The present invention introduces new methods and apparatuses for decoded picture buffer (DPB) management using reference picture set (RPS) where consecutive reference picture sets are conFIG.d such that reference pictures is set/marked as non-reference at appropriate instances and/or according to predetermined priorities. Using the present invention, the DPB size is kept at a minimum while supporting both optimal reference picture configuration and correct output reordering. Benefits of the present invention are in the form of improved coding efficiency and/or reduced memory storage for DPB.

### FIELD OF THE INVENTION

This invention can be used in any multimedia data coding and, more particularly, in coding of image and video contents utilizing inter-picture prediction.

### DESCRIPTION OF THE RELATED ART

State of the art video coding schemes, such as H.264 J MPEG-4 AVC (Advanced Video Coding) and HEVC (High-Efficiency Video Coding), perform encoding/decoding of image/video content using inter-picture prediction from previously encoded/decoded reference pictures, to exploit the information redundancy across consecutive pictures in time.

State of the art video coding schemes support output reordering of pictures, where coded pictures are outputted at a different order/sequence from their coding order. The output order (also known as display order) describes the order at which decoded pictures are outputted or displayed. The output order typically corresponds to the original order of uncompressed pictures during video capturing/creation. In contrast, the coding order describes the order at which pictures are decoded from a coded video bitstream. Output reordering improves coding efficiency in applications where some amount of output latency/delay is acceptable.

During video encoding, input pictures are arranged into groups of pictures (GOPs). For example, a GOP contains eight pictures having consecutive output order, as shown in FIG. 1. In FIG. 1, “I” indicates an intra picture while “B” indicates a bi-predicted inter picture, and uppercase (e.g. “B”) indicates a reference picture while lowercase (e.g. “b”) indicates a non-reference picture. Typically, a predetermined coding order is used repetitively over a number of GOPs. As shown in FIG. 1, coding of pictures in a different order from their output order allows the pictures b1, B2, b3, B4, b5, B6 and b7 to utilize bi-directional prediction in both forward and backward directions from previously coded/decoded reference pictures stored in the decoded picture buffer (DPB), thereby improving the coding efficiency. In FIG. 1, the primary referencing configuration of inter prediction is illustrated by arrows from reference pictures to target pictures. The coding structure illustrated in FIG. 1 is commonly known as hierarchical structure. Pictures are arranged into different hierarchical levels, whereas higher level pictures are inter-predicted from lower level pictures and the amount/strength of video compression increases from lower levels (less compression, hence higher fidelity) to higher levels (more compression, hence lower quality).

When output reordering is present (i.e. when coding order and output order are different), some pictures including non-reference pictures need to be stored/buffered in the DPB until their output time is reached. Such delayed output is necessary to ensure that pictures can be outputted at regular intervals. In the example in FIG. 1, non-reference pictures b3, b5 and b7 are stored in the DPB for 1, 1 and 2 picture intervals, respectively. However, storage of such non-reference pictures waiting to be outputted in the DPB reduces the available DPB space to store reference pictures required for efficient coding.

The HEVC video coding scheme performs DPB management using reference picture sets (also known as buffer descriptions). A reference picture set (RPS) is used for defining the pictures that are retained/included as reference pictures in the DPB, instead of defining the pictures that are to be set as non-reference out of a plurality of reference pictures. An RPS is essentially a list comprising all reference pictures in the DPB. An RPS is activated/applied at the start of the encoding/decoding process of a target picture. Pictures in the DPB that are not included in the active RPS are set as non-reference pictures (i.e. marked as “unused for reference”). Although non-reference pictures are not described in the active RPS, they remain in the DPB until their output time instance is reached, as previously described above.

HEVC DPB management using RPS different from the DPB management of AVC video coding scheme. In AVC, MMCO (memory management control operation) commands are sent at the slice header(s) of a reference picture for marking a reference picture as “unused as reference” (thereby setting the picture as a non-reference picture). The marking operation is performed at the end of the decoding process of the reference picture at which the MMCO command is sent. MMCO commands are not allowed to be sent at slice headers of non-reference pictures.

### SUMMARY OF THE INVENTION

### Problems that Invention is to Solve

One problem with the prior art DPB management scheme in AVC is that MMCO commands are only sent at slice headers of reference pictures. As a result, when one or more non-reference pictures requiring storage for output reordering are present, a reference picture preceding the non-reference pictures need to ensure that DPB space is available. MMCO command for marking a reference picture as a non-reference picture may be sent at the reference picture, although an empty/free DPB space may not be needed yet immediately after the decoding of the reference picture. Consequently, one or more non-reference pictures following the reference picture in coding order may not have optimal coding efficiency due to reduced choices of reference pictures.

Another problem with the prior art implementations of the DPB management scheme is that to achieve both optimal coding efficiency and correct output reordering, the prior art implementations use a large DPB size to contain both non-reference pictures waiting for output and reference pictures. However, large DPB size requires increased memory storage and implementation cost. Furthermore, DPB size is normatively restricted to a maximum limit for each specific combination of HEVC profile and level.

### Means of Solving the Problems

To solve the above problems, the present invention introduces new methods and apparatuses for DPB management using reference picture set (RPS) where consecutive reference picture sets are conFIG.d such that is reference pictures is set/marked as non-reference at appropriate instances and/or according to predetermined priorities. Using the present invention, the DPB size is kept at a minimum while supporting both optimal reference picture configuration and correct output reordering. Benefits of the present invention are in the form of improved coding efficiency and/or reduced memory storage for DPB.

### Effects of the Present Invention

The effect of the present invention is in the form of improved coding efficiency of inter-predicted pictures while keeping a small memory storage size for DPB. The present invention allows timely removal of pictures from the DPB so that reference pictures are kept available as inter prediction reference as long as possible without violating the maximum DPB size restriction.

### BRIEF DESCRIPTION OF THE DRAWINGS

FIG. 1 shows a diagram illustrating a hierarchical coding structure with 4 hierarchical levels.

FIG. 2 shows a block diagram illustrating a structure of video/image encoding apparatus according to the present invention.

FIG. 3 shows a structure of video/image decoding apparatus according to the present invention.

FIG. 4 shows a flowchart illustrating a first embodiment of an encoding process for a plurality of pictures according to the present invention.

FIG. 5 shows a flowchart illustrating a first embodiment of a decoding process for a plurality of pictures according to the present invention.

FIG. 6 shows a flowchart illustrating a second embodiment of an encoding process for a plurality of pictures according to the present invention.

FIG. 7 shows a flowchart illustrating a third embodiment of an encoding process for a plurality of pictures according to the present invention.

FIG. 8 shows a flowchart illustrating a second embodiment of a decoding process for a plurality of pictures according to the present invention.

FIG. 9 shows a diagram illustrating a hierarchical coding structure with 5 hierarchical levels.

FIG. 10 shows a diagram illustrating a hierarchical coding structure with 3 hierarchical levels.

FIG. 11 shows a diagram illustrating a first hierarchical coding structure with 2 hierarchical levels.

FIG. 12 shows a diagram illustrating a second hierarchical coding structure with 2 hierarchical levels.

FIG. 13 shows a syntax diagram illustrating the location of the parameters specifying maximum DPB size and reference picture sets.

FIG. 14 shows a syntax diagram illustrating the location of the parameters specifying maximum DPB size and reference picture sets.

FIG. 15 shows an overall configuration of a content providing system for implementing content distribution services.

FIG. 16 shows an overall configuration of a digital broadcasting system.

FIG. 17 shows a block diagram illustrating an example of a configuration of a television.

FIG. 18 shows a block diagram illustrating an example of a configuration of an information reproducing/recording unit that reads and writes information from and on a recording medium that is an optical disk.

FIG. 19 shows an example of a configuration of a recording medium that is an optical disk.

FIG. 20A shows an example of a cellular phone.

FIG. 20B is a block diagram showing an example of a configuration of a cellular phone.

FIG. 21 illustrates a structure of multiplexed data.

FIG. 22 schematically shows how each stream is multiplexed in multiplexed data.

FIG. 23 shows how a video stream is stored in a stream of PES packets in more detail.

FIG. 24 shows a structure of TS packets and source packets in the multiplexed data.

FIG. 25 shows a data structure of a PMT.

FIG. 26 shows an internal structure of multiplexed data information.

FIG. 27 shows an internal structure of stream attribute information.

FIG. 28 shows steps for identifying video data.

FIG. 29 shows an example of a configuration of an integrated circuit for implementing the moving picture coding method and the moving picture decoding method according to each of embodiments.

FIG. 30 shows a configuration for switching between driving frequencies.

FIG. 31 shows steps for identifying video data and switching between driving frequencies.

FIG. 32 shows an example of a look-up table in which video data standards are associated with driving frequencies.

FIG. 33A is a diagram showing an example of a configuration for sharing a module of a signal processing unit.

FIG. 33B is a diagram showing another example of a configuration for sharing a module of the signal processing unit.

### DETAILED DESCRIPTION OF THE INVENTION

Hereinafter, the present invention is described with reference to the drawings.

### [Encoding Apparatus]

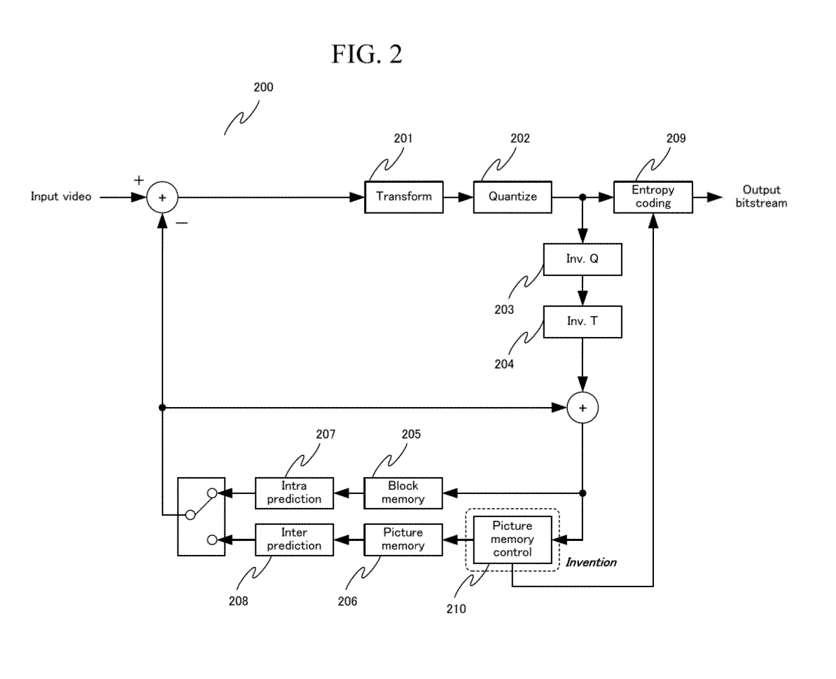

FIG. 2 is a block diagram which shows a structure of video/image encoding apparatus 200 in the present invention.

The video/image encoding apparatus 200 is an apparatus for encoding an input video/image bit stream on a block-by-block basis so as to generate an encoded output bit stream, and comprises as shown in FIG. 2, a transformation unit 201, a quantization unit 202, an inverse quantization unit 203, an inverse transformation unit 204, a block memory 205, a picture memory 206, an intra prediction unit 207, an inter prediction unit 208, an entropy coding unit 209, a picture memory control unit 210.

An input video is inputted to an adder, and the added value is outputted to the transformation unit 201. The transformation unit 201 transforms the added values into frequency coefficients, and outputs the resulting frequency coefficients to the quantization unit 202. The quantization unit 202 quantizes the inputted frequency coefficients, and outputs the resulting quantized values to the inverse quantization unit 203 and the entropy coding unit 209. The entropy coding unit 209 encodes the quantized values outputted from the quantization unit 202, and outputs a bit stream.

The inverse quantization unit 203 inversely quantizes the sample values outputted from the quantization unit 202, and outputs the frequency coefficients to the inverse transformation unit 204. The inverse transformation unit 204 performs inverse frequency transform on the frequency coefficients so as to transform the frequency coefficients into sample values of the bit stream, and outputs the resulting sample values to an adder. The adder adds the sample values of the bit stream outputted from the inverse transformation unit 204 to the predicted video/image values outputted from the intra/inter prediction unit 207, 208, and outputs the resulting added values to the block memory 205 or the picture memory 206 (through the picture memory control unit 210) for further prediction. The intra/inter prediction unit 207, 208 searches within reconstructed videos/images stored in the block memory 205 or the picture memory 206, and estimates a video/image area which is e.g. most similar to the input videos/images for prediction.

The picture memory control unit 210 manages the reconstructed pictures stored in the picture memory 206. Memory management processes performed by the picture memory control unit 210 comprises determining whether a reconstructed picture is kept or removed from the picture memory 206, constructing reference picture set to be used by the inter prediction unit 208, and determining the control parameters for controlling reference picture set to be written by the entropy coding unit 209 into the output bitstream.

### [Encoding Process]

Next, a description is given to the operations of the video image encoding apparatus 200 as mentioned above.

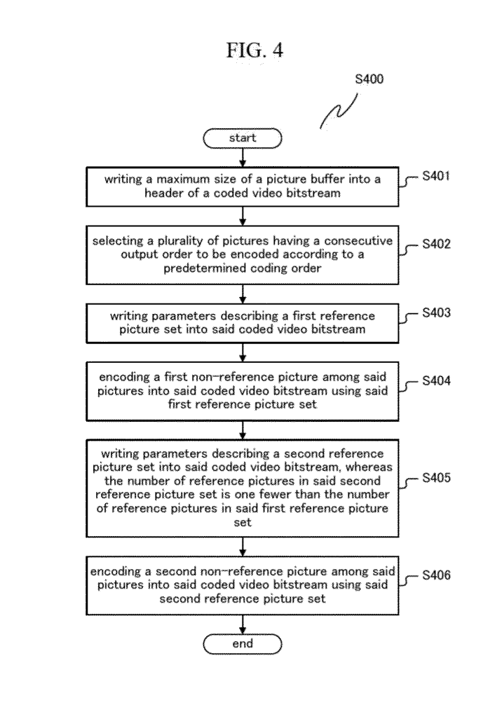

FIG. 4 is a flowchart which shows a first embodiment of an encoding process for a plurality of pictures S400 as performed by the video/image encoding apparatus 200 according to the present invention.

Step S401 writes a maximum size of a picture buffer into a header of a coded video bitstream. The maximum size (for example in units of bytes) determines the maximum number of pictures that are allowed (i.e. can be stored) in the picture buffer. One example of deriving the maximum number of pictures from the maximum size is dividing the maximum size (in bytes) by the size of one reconstructed/decoded picture (in bytes). Step S402 then selects a plurality of pictures having a consecutive output order to be encoded according to a predetermined coding order, whereas the coding order is different from the output order. According to the coding order, one or more non-reference pictures among the plurality of pictures are required to be stored in the picture buffer for at least one picture interval, so that the plurality of pictures can be outputted correctly according to their the output order.

Next, Step S403 writes parameters describing a first reference picture set into the coded video bitstream, whereas the number of reference pictures in the first reference picture set is one fewer than the maximum number of pictures allowed in the picture buffer. Step S404 then encodes a first non-reference picture among the pictures into the coded video bitstream using the first reference picture set.

Next, Step S405 writes parameters describing a second reference picture set into the coded video bitstream, whereas the number of reference pictures in the second reference picture set is one fewer than the number of reference pictures in the first reference picture set. The second reference picture set does not include a predetermined reference picture that was previously included in the first reference picture set, thereby setting the predetermined reference picture as a non-reference picture (i.e. marked as “unused for reference”). When a new/incoming picture needs to be stored in the DPB, a non-reference picture for which the output time instance is over can be overwritten by the new picture. Step S406 then encodes a second non-reference picture among the pictures into the coded video bitstream using the second reference picture set.

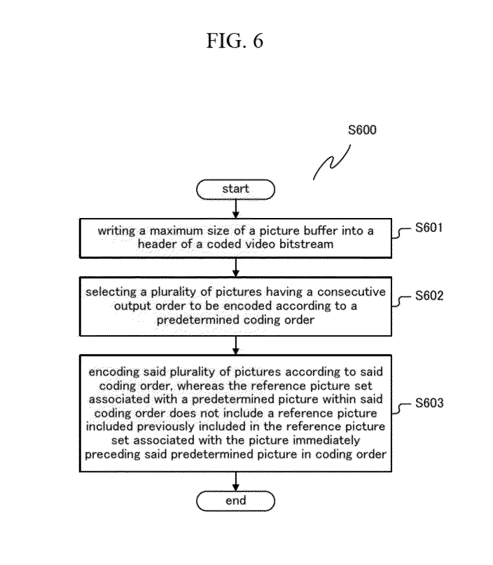

FIG. 6 is a flowchart which shows a second embodiment of an encoding process for a plurality of pictures S600 as performed by the video/image encoding apparatus 200 according to the present invention.

Step S601 writes a maximum size of a picture buffer into a header of a coded video bitstream. The maximum size determines the maximum number of pictures that are allowed (i.e. can be stored) in the picture buffer. Step S602 then selects a plurality of pictures having a consecutive output order to be encoded according to a predetermined coding order, whereas the coding order is different from the output order. According to the coding order one or more non-reference pictures among the plurality of pictures are required to be stored in the picture buffer for at least one picture interval, so that the plurality of pictures can be outputted correctly according to their the output order.

Next, Step S603 encodes the plurality of pictures according to the coding order. In Step S603, the reference picture set associated with a predetermined picture within the coding order does not include a reference picture that was previously included in the reference picture set associated with the picture immediately preceding the predetermined picture in coding order. The number of pictures in the reference picture set associated with the predetermined picture is at most two fewer than the maximum number of pictures allowed in the picture buffer.

In one possible embodiment of the present invention, the predetermined picture (i.e. the picture having a reference picture set which does not include a reference picture that was previously included in the reference picture set associated with the preceding picture) occurs once out of every two consecutive pictures (i.e. every other picture) within the coding order.

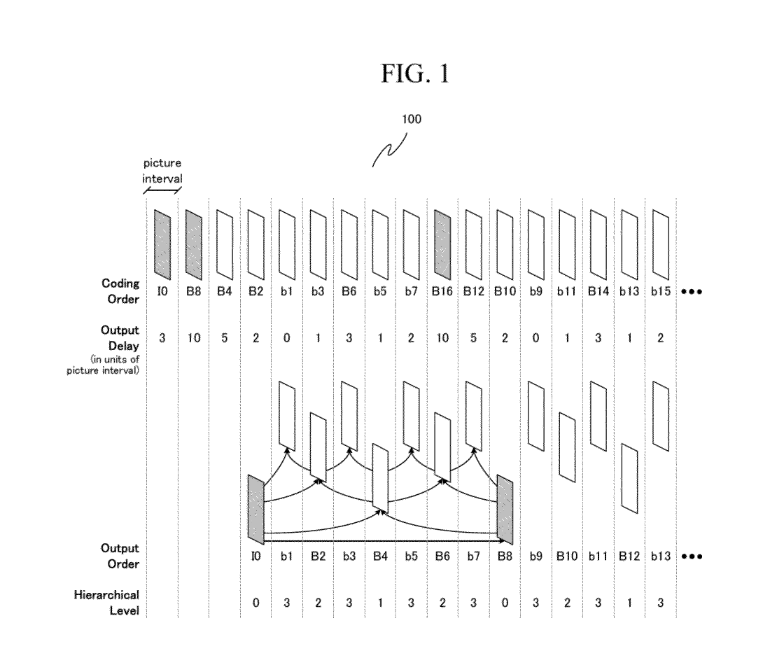

Returning to the exemplary coding structure in FIG. 1, the sequence of operations in the encoding process according to the present invention is listed in Table 1. FIG. 1 and Table 1 describes hierarchical coding structure with 4 levels, which periodically repeats itself every 8 pictures. In Table 1, IDR (instantaneous decoding refresh) picture is used instead of a generic I picture. IDR picture is a special type of I picture at which the whole DPB is flushed/emptied. The DPB size is set such that maximum number of pictures allowed in the DPB is 5. Each row in Table 1 represents a picture interval from the start to the end of the encoding/decoding process for a target picture, and the rows are arranged from top to bottom according to the predetermined coding order. Column C103 shows the picture to be outputted at the end of encoding/decoding process for the target picture. Column C104 shows the DPB content/status at the start of encoding/decoding process for the target picture. Working buffer (WB) is the picture buffer in the DPB into which reconstructed samples of the target picture are stored. Column C105 shows the reference picture to be excluded/removed from the reference picture set (RPS) associated with the target picture. When an entry in Column C105 is empty, the RPS contains the same reference pictures as the preceding RPS in the row above. Column C106 contains a remark on DPB operation and RPS reference picture exclusion/removal.

In the exemplary embodiment of Table 1, the decision process/rationale for selecting one reference picture to be excluded/removed from RPS among a plurality of reference pictures is as follows:
When there are two or more reference pictures that have been output (i.e. the output time instance is over) and the hierarchical levels of these pictures are different, the reference picture having the highest hierarchical level is selected to be excluded/removed from RPS.
Otherwise, when there are two or more reference pictures that have been output and the hierarchical levels of these pictures are the same, the reference picture having the largest temporal distance (i.e. output order distance) is selected to be excluded/removed from RPS.

TABLE 1
Sequence of operations for 4-level hierarchical structure
starting from IDR picture without leading pictures

| | | (C103) | | | | | | (C105) | |
|---|---|---|---|---|---|---|---|---|---|
| (C101) | (C102) | Picture | | | | | | Exclude | |
| Target | Output | To | (C104) | | | | | From | (C106) |
| Picture | Delay | Output | DPB Content | | | | | RPS | Remark |
| IDR0 | 3 | — | WB | | | | | | |
| B8 | 10 | — | WB | IDR0 | | | | | |
| B4 | 5 | — | WB | IDR0 | B8 | | | | |
| B2 | 2 | IDR0 | WB | IDR0 | B8 | B4 | | | |
| b1 | 0 | b1 | WB | IDR0 | B8 | B4 | B2 | | |
| b3 | 1 | B2 | WB | IDR0 | B8 | B4 | B2 | | |
| B6 | 3 | b3 | WB | IDR0 | B8 | B4 | b3 | B2 | Exclude |
| | | | | | | | | | either |
| | | | | | | | | | IDR0 or |
| | | | | | | | | | B2 from |
| | | | | | | | | | RPS. |
| | | | | | | | | | Select B2 |
| | | | | | | | | | due to |
| | | | | | | | | | higher |
| | | | | | | | | | level. |
| b5 | 1 | B4 | WB | IDR0 | B8 | B4 | B6 | | B6 |
| | | | | | | | | | overwrites |
| | | | | | | | | | b3. |
| b7 | 2 | b5 | WB | IDR0 | B8 | B6 | b5 | B4 | Exclude |
| | | | | | | | | | either |
| | | | | | | | | | IDR0 or |
| | | | | | | | | | B4 from |
| | | | | | | | | | RPS. |
| | | | | | | | | | Select B4 |
| | | | | | | | | | due to |
| | | | | | | | | | higher |
| | | | | | | | | | level. |
| B16 | 10 | B6 | WB | IDR0 | B8 | B6 | b7 | | b7 |
| | | | | | | | | | overwrites |
| | | | | | | | | | b5. |
| B12 | 5 | b7 | WB | IDR0 | B8 | b7 | B16 | B6 | Exclude |
| | | | | | | | | | either |
| | | | | | | | | | IDR0 or |
| | | | | | | | | | B6 from |
| | | | | | | | | | RPS. |
| | | | | | | | | | Select B6 |
| | | | | | | | | | due to |
| | | | | | | | | | higher |
| | | | | | | | | | level. |
| B10 | 2 | B8 | WB | IDR0 | B8 | B16 | B12 | | B12 |
| | | | | | | | | | overwrites |
| | | | | | | | | | b7. |
| b9 | 0 | b9 | WB | B8 | B16 | B12 | B10 | IDR0 | Exclude |
| | | | | | | | | | either |
| | | | | | | | | | IDR0 or |
| | | | | | | | | | B8 from |
| | | | | | | | | | RPS. |
| | | | | | | | | | Select |
| | | | | | | | | | IDR0 due |
| | | | | | | | | | to longer |
| | | | | | | | | | distance. |
| b11 | 1 | B10 | WB | B8 | B16 | B12 | B10 | | |
| B14 | 3 | b11 | WB | B8 | B16 | B12 | b11 | B10 | Exclude |
| | | | | | | | | | either B8 |
| | | | | | | | | | or B10 |
| | | | | | | | | | from RPS. |
| | | | | | | | | | Select |
| | | | | | | | | | B10 due |
| | | | | | | | | | to higher |
| | | | | | | | | | level. |
| b13 | 1 | B12 | WB | B8 | B16 | B12 | B14 | | B14 |
| | | | | | | | | | overwrites |
| | | | | | | | | | b11. |
| b15 | 2 | b13 | WB | B8 | B16 | B14 | b13 | B12 | Exclude |
| | | | | | | | | | either B8 |
| | | | | | | | | | or B12 |
| | | | | | | | | | from RPS. |
| | | | | | | | | | Select |
| | | | | | | | | | B12 due |
| | | | | | | | | | to higher |
| | | | | | | | | | level. |

As shown in Table 1, four reference pictures are available for inter-prediction of b5, namely IDR0, 68, 64 and 66. The output delay of b5 is 1, hence it needs to be stored in the DPB for I picture interval. Due to DPB space limitation, at the end of b5 encoding/decoding, one of the four reference pictures need to be removed from the DPB to make space for b5. According the prior art AVC video coding scheme, a non-reference picture such as b7 cannot mark a reference picture as “unused as reference”, therefore 64 must be removed early by 66 (in AVC, reference picture marking is performed at the end of the encoding/decoding of the picture carrying the removal command/parameters, i.e. 66). As a result, number of available reference pictures for inter-prediction of b5 is reduced. On the other hand, the present invention allows 64 to be removed only at the start of b7 encoding/decoding, as described above for the first embodiment of an encoding process for a plurality of pictures S400. Therefore, the benefit of the present invention is to timely removal of B4, thereby allowing b5 to still make full use of all four reference pictures. Consequently, the coding efficiency of b5 is optimized.

As shown in Table 1, DPB is increasingly filled from IDR0 to B2 and is fully occupied at the start of b1 encoding/decoding. To encode/decode B6, one reference picture needs to be removed from the DPB at the start of B6 encoding/decoding. According to the exemplary decision process, B2 is excluded/removed as it is located at hierarchical level 2, as opposed to IDR0 is located at hierarchical level 0 (as shown in FIG. 1). A similar decision and exclusion/removal process continues throughout the encoding of the plurality of pictures, where reference pictures to be excluded/removed from RPS are indicated in the respective RPS parameters written into the coded video bitstream. Such exclusion/removal process is performed according to the second embodiment of an encoding process for a plurality of pictures S600 as described above. As shown in Column C105 of Table 1, exclusion/removal of reference pictures from RPS is performed at every other picture (i.e. performed once every two consecutive pictures in coding order).

The exemplary coding structure in FIG. 1 and Table 1 does not include leading pictures. Leading pictures are pictures following an intra picture in coding order but preceding the intra picture in output order. Table 2 shows the sequence of operations for 4-level hierarchical structure starting from an IDR picture with leading pictures. Leading pictures are shown with negative output order relative to IDR0, for example B-2 refers to the B picture that precedes IDR0 in output order by 2 picture intervals. As shown in Column C205 of Table 2, reference pictures are excluded/removed from RPS at every other picture when the DPB is full.

TABLE 2
Sequence of operations for 4-level hierarchical structure
starting from IDR picture with leading pictures

| | | (C203) | | | | | | (C205) | |
|---|---|---|---|---|---|---|---|---|---|
| (C201) | (C202) | Picture | | | | | | Exclude | |
| Target | Output | To | (C204) | | | | | From | (C206) |
| Picture | Delay | Output | DPB Content | | | | | RPS | Remark |
| IDR0 | 10 | — | WB | | | | | | |
| B-4 | 5 | — | WB | IDR0 | | | | | |
| B-6 | 2 | — | WB | IDR0 | B-4 | | | | |
| b-7 | 0 | b-7 | WB | IDR0 | B-4 | B-6 | | | |
| b-5 | 1 | B-6 | WB | IDR0 | B-4 | B-6 | | | |
| B-2 | 3 | b-5 | WB | IDR0 | B-4 | B-6 | b-5 | | |
| b-3 | 1 | B-4 | WB | IDR0 | B-4 | B-6 | B-2 | | B-2 |
| | | | | | | | | | overwrites |
| | | | | | | | | | b-5. |
| b-1 | 2 | b-3 | WB | IDR0 | B-4 | B-2 | b-3 | B-6 | Exclude |
| | | | | | | | | | either B-4 |
| | | | | | | | | | or B-6 |
| | | | | | | | | | from RPS. |
| | | | | | | | | | Select B-6 |
| | | | | | | | | | due to |
| | | | | | | | | | higher |
| | | | | | | | | | level. |
| B8 | 10 | B-2 | WB | IDR0 | B-4 | B-2 | b-1 | | b-1 |
| | | | | | | | | | overwrites |
| | | | | | | | | | b-3. |
| B4 | 5 | b-1 | WB | IDR0 | B-4 | b-1 | B8 | B-2 | Exclude |
| | | | | | | | | | either B-4 |
| | | | | | | | | | or B-2 |
| | | | | | | | | | from RPS. |
| | | | | | | | | | Select B-2 |
| | | | | | | | | | due to |
| | | | | | | | | | higher |
| | | | | | | | | | level. |
| B2 | 2 | IDR0 | WB | IDR0 | B-4 | B8 | B4 | | B4 |
| | | | | | | | | | overwrites |
| | | | | | | | | | b-1. |
| b1 | 0 | b1 | WB | IDR0 | B8 | B4 | B2 | B-4 | Exclude |
| | | | | | | | | | either |
| | | | | | | | | | IDR0 or |
| | | | | | | | | | B-4 from |
| | | | | | | | | | RPS. |
| | | | | | | | | | Select B-4 |
| | | | | | | | | | due to |
| | | | | | | | | | higher |
| | | | | | | | | | level. |
| b3 | 1 | B2 | WB | IDR0 | B8 | B4 | B2 | | |
| B6 | 3 | b3 | WB | IDR0 | B8 | B4 | b3 | B2 | Exclude |
| | | | | | | | | | either |
| | | | | | | | | | IDR0 or |
| | | | | | | | | | B2 from |
| | | | | | | | | | RPS. |
| | | | | | | | | | Select B2 |
| | | | | | | | | | due to |
| | | | | | | | | | higher |
| | | | | | | | | | level. |
| b5 | 1 | B4 | WB | IDR0 | B8 | B4 | B6 | | B6 |
| | | | | | | | | | overwrites |
| | | | | | | | | | b3. |
| b7 | 2 | b5 | WB | IDR0 | B8 | B6 | b5 | B4 | Exclude |
| | | | | | | | | | either |
| | | | | | | | | | IDR0 or |
| | | | | | | | | | B4 from |
| | | | | | | | | | RPS. |
| | | | | | | | | | Select B4 |
| | | | | | | | | | due to |
| | | | | | | | | | higher |
| | | | | | | | | | level. |
| B16 | 10 | B6 | WB | IDR0 | B8 | B6 | b7 | | b7 |
| | | | | | | | | | overwrites |
| | | | | | | | | | b5. |
| B12 | 5 | b7 | WB | IDR0 | B8 | b7 | B16 | B6 | Exclude |
| | | | | | | | | | either |
| | | | | | | | | | IDR0 or |
| | | | | | | | | | B6 from |
| | | | | | | | | | RPS. |
| | | | | | | | | | Select B6 |
| | | | | | | | | | due to |
| | | | | | | | | | higher |
| | | | | | | | | | level. |
| B10 | 2 | B8 | WB | IDR0 | B8 | B16 | B12 | | B12 |
| | | | | | | | | | overwrites |
| | | | | | | | | | b7. |
| b9 | 0 | b9 | WB | B8 | B16 | B12 | B10 | IDR0 | Exclude |
| | | | | | | | | | either |
| | | | | | | | | | IDR0 or |
| | | | | | | | | | B8 from |
| | | | | | | | | | RPS. |
| | | | | | | | | | Select |
| | | | | | | | | | IDR0 due |
| | | | | | | | | | to longer |
| | | | | | | | | | distance. |
| b11 | 1 | B10 | WB | B8 | B16 | B12 | B10 | | |
| B14 | 3 | b11 | WB | B8 | B16 | B12 | b11 | B10 | Exclude |
| | | | | | | | | | either B8 |
| | | | | | | | | | or B10 |
| | | | | | | | | | from RPS. |
| | | | | | | | | | Select |
| | | | | | | | | | B10 due |
| | | | | | | | | | to higher |
| | | | | | | | | | level. |
| b13 | 1 | B12 | WB | B8 | B16 | B12 | B14 | | B14 |
| | | | | | | | | | overwrites |
| | | | | | | | | | b11. |
| b15 | 2 | b13 | WB | B8 | B16 | B14 | b13 | B12 | Exclude |
| | | | | | | | | | either B8 |
| | | | | | | | | | or B12 |
| | | | | | | | | | from RPS. |
| | | | | | | | | | Select |
| | | | | | | | | | B12 due |
| | | | | | | | | | to higher |
| | | | | | | | | | level. |

Besides the IDR picture, the HEVC video coding scheme supports the CRA (dean random access) picture. The CRA picture mandates that any picture following the CRA picture in both coding order and display order shall not use inter prediction from any picture that precedes the CRA picture either in coding order or output order, and any picture that precedes the CRA picture in coding order shall also precede the CRA picture in output order. Table 3 shows the sequence of operations for 4-level hierarchical structure starting from CRA picture with leading pictures. As shown in Column C305 of Table 3, reference pictures are excluded/removed from RPS at every other picture when the DPB is full.

TABLE 3
Sequence of operations for 4-level hierarchical structure
starting from CRA picture with leading pictures

| | | (C303) | | | | | | (C305) | |
|---|---|---|---|---|---|---|---|---|---|
| (C301) | (C302) | Picture | | | | | | Exclude | |
| Target | Output | To | (C304) | | | | | From | (C306) |
| Picture | Delay | Output | DPB Content | | | | | RPS | Remark |
| CRA0 | 10 | B-10 | WB | B-16 | B-8 | B-10 | b-9 | | b-9 |
| | | | | | | | | | overwrites |
| | | | | | | | | | b-11. |
| B-4 | 5 | b-9 | WB | B-16 | B-8 | b-9 | CRA0 | B-10 | Exclude |
| | | | | | | | | | either B- |
| | | | | | | | | | 16 or B- |
| | | | | | | | | | 10 from |
| | | | | | | | | | RPS. |
| | | | | | | | | | Select B- |
| | | | | | | | | | 10 due to |
| | | | | | | | | | higher |
| | | | | | | | | | level. |
| B-6 | 2 | B-8 | WB | B-16 | B-8 | CRA0 | B-4 | | B-4 |
| | | | | | | | | | overwrites |
| | | | | | | | | | b-9. |
| b-7 | 0 | b-7 | WB | B-8 | CRA0 | B-4 | B-6 | B-16 | Exclude |
| | | | | | | | | | either B-8 |
| | | | | | | | | | or B-16 |
| | | | | | | | | | from RPS. |
| | | | | | | | | | Select B- |
| | | | | | | | | | 16 due to |
| | | | | | | | | | longer |
| | | | | | | | | | distance. |
| b-5 | 1 | B-6 | WB | B-8 | CRA0 | B-4 | B-6 | | |
| B-2 | 3 | b-5 | WB | B-8 | CRA0 | B-4 | b-5 | B-6 | Exclude |
| | | | | | | | | | either B-8 |
| | | | | | | | | | or B-6 |
| | | | | | | | | | from RPS. |
| | | | | | | | | | Select B-6 |
| | | | | | | | | | due to |
| | | | | | | | | | higher |
| | | | | | | | | | level. |
| b-3 | 1 | B-4 | WB | B-8 | CRA0 | B-4 | B-2 | | B-2 |
| | | | | | | | | | overwrites |
| | | | | | | | | | b-5 |
| b-1 | 2 | b-3 | WB | B-8 | CRA0 | B-2 | b-3 | B-4 | Exclude |
| | | | | | | | | | either B-8 |
| | | | | | | | | | or B-4 |
| | | | | | | | | | from RPS. |
| | | | | | | | | | Select B-4 |
| | | | | | | | | | due to |
| | | | | | | | | | higher |
| | | | | | | | | | level. |
| B8 | 10 | B-2 | WB | CRA0 | B-2 | b-1 | | | Leading |
| | | | | | | | | | pictures |
| | | | | | | | | | are |
| | | | | | | | | | excluded |
| | | | | | | | | | from RPS. |
| | | | | | | | | | B-2 stays |
| | | | | | | | | | in DPB as |
| | | | | | | | | | non- |
| | | | | | | | | | reference |
| | | | | | | | | | picture. |
| B4 | 5 | b-1 | WB | CRA0 | b-1 | B8 | | | |
| B2 | 2 | CRA0 | WB | CRA0 | B8 | B4 | | | |
| b1 | 0 | b1 | WB | CRA0 | B8 | B4 | B2 | | |
| b3 | 1 | B2 | WB | CRA0 | B8 | B4 | B2 | | |
| B6 | 3 | b3 | WB | CRA0 | B8 | B4 | b3 | B2 | Exclude |
| | | | | | | | | | either |
| | | | | | | | | | IDR0 or |
| | | | | | | | | | B2 from |
| | | | | | | | | | RPS. |
| | | | | | | | | | Select B2 |
| | | | | | | | | | due to |
| | | | | | | | | | higher |
| | | | | | | | | | level. |
| b5 | 1 | B4 | WB | CRA0 | B8 | B4 | B6 | | B6 |
| | | | | | | | | | overwrites |
| | | | | | | | | | b3. |
| b7 | 2 | b5 | WB | CRA0 | B8 | B6 | b5 | B4 | Exclude |
| | | | | | | | | | either |
| | | | | | | | | | IDR0 or |
| | | | | | | | | | B4 from |
| | | | | | | | | | RPS. |
| | | | | | | | | | Select B4 |
| | | | | | | | | | due to |
| | | | | | | | | | higher |
| | | | | | | | | | level. |
| B16 | 10 | B6 | WB | CRA0 | B8 | B6 | b7 | | b7 |
| | | | | | | | | | overwrites |
| | | | | | | | | | b5. |
| B12 | 5 | b7 | WB | CRA0 | B8 | b7 | B16 | B6 | Exclude |
| | | | | | | | | | either |
| | | | | | | | | | IDR0 or |
| | | | | | | | | | B6 from |
| | | | | | | | | | RPS. |
| | | | | | | | | | Select B6 |
| | | | | | | | | | due to |
| | | | | | | | | | higher |
| | | | | | | | | | level. |
| B10 | 2 | B8 | WB | CRA0 | B8 | B16 | B12 | | B12 |
| | | | | | | | | | overwrites |
| | | | | | | | | | b7. |
| b9 | 0 | b9 | WB | B8 | B16 | B12 | B10 | IDR0 | Exclude |
| | | | | | | | | | either |
| | | | | | | | | | IDR0 or |
| | | | | | | | | | B8 from |
| | | | | | | | | | RPS. |
| | | | | | | | | | Select |
| | | | | | | | | | IDR0 due |
| | | | | | | | | | to longer |
| | | | | | | | | | distance. |
| b11 | 1 | B10 | WB | B8 | B16 | B12 | B10 | | |
| B14 | 3 | b11 | WB | B8 | B16 | B12 | b11 | B10 | Exclude |
| | | | | | | | | | either B8 |
| | | | | | | | | | or B10 |
| | | | | | | | | | from RPS. |
| | | | | | | | | | Select |
| | | | | | | | | | B10 due |
| | | | | | | | | | to higher |
| | | | | | | | | | level. |
| b13 | 1 | B12 | WB | B8 | B16 | B12 | B14 | | B14 |
| | | | | | | | | | overwrites |
| | | | | | | | | | b11. |
| b15 | 2 | b13 | WB | B8 | B16 | B14 | b13 | B12 | Exclude |
| | | | | | | | | | either B8 |
| | | | | | | | | | or B12 |
| | | | | | | | | | from RPS. |
| | | | | | | | | | Select |
| | | | | | | | | | B12 due |
| | | | | | | | | | to higher |
| | | | | | | | | | level. |

As shown in Table 1, Table 2 and Table 3, regular predetermined exclusion/removal of reference picture from RPS is started when the DPB is fully occupied. An alternative embodiment of the present invention which takes into account DPB fullness is presented in the following.

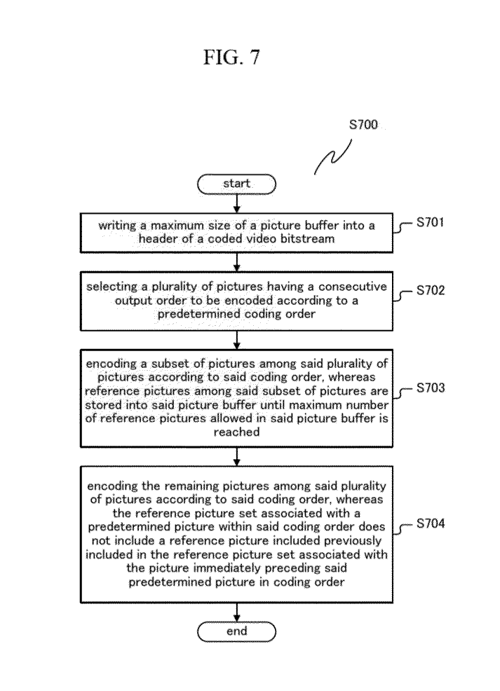

FIG. 7 is a flowchart which shows a third embodiment of an encoding process for a plurality of pictures S700 as performed by the video/image encoding apparatus 200 according to the present invention.

Step S701 writes a maximum size of a picture buffer into a header of a coded video bitstream. The maximum size determines the maximum number of pictures that are allowed (i.e. can be stored) in the picture buffer. Step S702 then selects a plurality of pictures having a consecutive output order to be encoded according to a predetermined coding order, whereas the coding order is different from the output order. According to the coding order one or more non-reference pictures among the plurality of pictures are required to be stored in the picture buffer for at least one picture interval, so that the plurality of pictures can be outputted correctly according to their the output order.

Next, Step S703 encodes a subset of pictures among the plurality of pictures according to the coding order, whereas reference pictures among the subset of pictures are stored into the picture buffer until maximum number of reference pictures allowed in the picture buffer is reached.

Next, Step S704 encodes the remaining pictures among the plurality of pictures according to the coding order. In Step S603, the reference picture set associated with a predetermined picture within the coding order does not include a reference picture that was previously included in the reference picture set associated with the picture immediately preceding the predetermined picture in coding order. The number of pictures in the reference picture set associated with the predetermined picture is at most two fewer than the maximum number of pictures allowed in the picture buffer.

Besides the 4-level hierarchical coding structure shown in FIG. 1, Table 1, Table 2 and Table 3, other coding structures are commonly used for coding video/image.

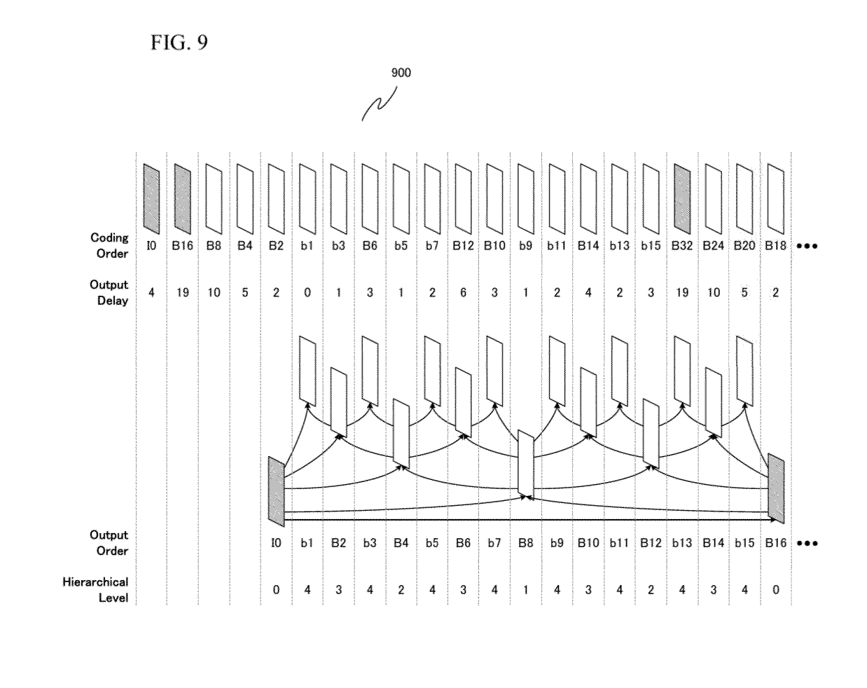

FIG. 9 and Table 4 show a hierarchical coding structure with 5 levels, which periodically repeats itself every 16 pictures. In Table 4, IDR (instantaneous decoding refresh) picture is used instead of a generic I picture, similar to Table 1. The DPB size is set such that maximum number of pictures allowed in the DPB is 6.

TABLE 4
Sequence of operations for 5-level hierarchical structure
starting from IDR picture without leading pictures

| | | (C403) | | | | | | | (C405) | |
|---|---|---|---|---|---|---|---|---|---|---|
| (C401) | (C402) | Picture | | | | | | | Exclude | |
| Target | Output | To | (C404) | | | | | | From | (C406) |
| Picture | Delay | Output | DPB Content | | | | | | RPS | Remark |
| IDR0 | 4 | — | WB | | | | | | | |
| B16 | 19 | — | WB | IDR0 | | | | | | |
| B8 | 10 | — | WB | IDR0 | B16 | | | | | |
| B4 | 5 | — | WB | IDR0 | B16 | B8 | | | | |
| B2 | 2 | IDR0 | WB | IDR0 | B16 | B8 | B4 | | | |
| b1 | 0 | b1 | WB | IDR0 | B16 | B8 | B4 | B2 | | |
| b3 | 1 | B2 | WB | IDR0 | B16 | B8 | B4 | B2 | | |
| B6 | 3 | b3 | WB | IDR0 | B16 | B8 | B4 | b3 | B2 | Exclude |
| | | | | | | | | | | either |
| | | | | | | | | | | IDR0 or |
| | | | | | | | | | | B2. Select |
| | | | | | | | | | | B2 due to |
| | | | | | | | | | | higher |
| | | | | | | | | | | level. |
| b5 | 1 | B4 | WB | IDR0 | B16 | B8 | B4 | B6 | | B6 |
| | | | | | | | | | | overwrites |
| | | | | | | | | | | b3. |
| b7 | 2 | b5 | WB | IDR0 | B16 | B8 | B6 | b5 | B4 | Exclude |
| | | | | | | | | | | either |
| | | | | | | | | | | IDR0 or |
| | | | | | | | | | | B4. Select |
| | | | | | | | | | | B4 due to |
| | | | | | | | | | | higher |
| | | | | | | | | | | level. |
| B12 | 6 | B6 | WB | IDR0 | B16 | B8 | B6 | b7 | | b7 |
| | | | | | | | | | | overwrites |
| | | | | | | | | | | b5. |
| B10 | 3 | b7 | WB | IDR0 | B16 | B8 | b7 | B12 | B6 | Exclude |
| | | | | | | | | | | either |
| | | | | | | | | | | IDR0 or |
| | | | | | | | | | | B6. Select |
| | | | | | | | | | | B6 due to |
| | | | | | | | | | | higher |
| | | | | | | | | | | level. |
| b9 | 1 | B8 | WB | IDR0 | B16 | B8 | B12 | B10 | | B10 |
| | | | | | | | | | | overwrites |
| | | | | | | | | | | b7. |
| b11 | 2 | b9 | WB | IDR0 | B16 | B12 | B10 | b9 | B8 | Exclude |
| | | | | | | | | | | either |
| | | | | | | | | | | IDR0 or |
| | | | | | | | | | | B8. Select |
| | | | | | | | | | | B8 due to |
| | | | | | | | | | | higher |
| | | | | | | | | | | level. |
| B14 | 4 | B10 | WB | IDR0 | B16 | B12 | B10 | b11 | | b11 |
| | | | | | | | | | | overwrites |
| | | | | | | | | | | b9. |
| b13 | 2 | b11 | WB | IDR0 | B16 | B12 | b11 | B14 | B10 | Exclude |
| | | | | | | | | | | either |
| | | | | | | | | | | IDR0 or |
| | | | | | | | | | | B10. |
| | | | | | | | | | | Select |
| | | | | | | | | | | B10 due |
| | | | | | | | | | | to higher |
| | | | | | | | | | | level. |
| b15 | 3 | B12 | WB | IDR0 | B16 | B12 | B14 | b13 | | b13 |
| | | | | | | | | | | overwrites |
| | | | | | | | | | | b11. |
| B32 | 19 | b13 | WB | IDR0 | B16 | B14 | b13 | b15 | B12 | Exclude |
| | | | | | | | | | | either |
| | | | | | | | | | | IDR0 or |
| | | | | | | | | | | B12. |
| | | | | | | | | | | Select |
| | | | | | | | | | | B12 due |
| | | | | | | | | | | to higher |
| | | | | | | | | | | level. |
| B24 | 10 | B14 | WB | IDR0 | B16 | B14 | b15 | B32 | | B32 |
| | | | | | | | | | | overwrites |
| | | | | | | | | | | b13. |
| B20 | 5 | b15 | WB | IDR0 | B16 | b15 | B32 | B24 | B14 | Exclude |
| | | | | | | | | | | either |
| | | | | | | | | | | IDR0 or |
| | | | | | | | | | | B14. |
| | | | | | | | | | | Select |
| | | | | | | | | | | B14 due |
| | | | | | | | | | | to higher |
| | | | | | | | | | | level. |
| B18 | 2 | B16 | WB | IDR0 | B16 | B32 | B24 | B20 | | B20 |
| | | | | | | | | | | overwrites |
| | | | | | | | | | | b15. |
| b17 | 0 | b17 | WB | B16 | B32 | B24 | B20 | B18 | IDR0 | Exclude |
| | | | | | | | | | | either B16 |
| | | | | | | | | | | or IDR0. |
| | | | | | | | | | | Select |
| | | | | | | | | | | IDR0 due |
| | | | | | | | | | | to longer |
| | | | | | | | | | | distance. |
| b19 | 1 | B18 | WB | B16 | B32 | B24 | B20 | B18 | | |
| B22 | 3 | b19 | WB | B16 | B32 | B24 | B20 | b19 | B18 | Exclude |
| | | | | | | | | | | either B16 |
| | | | | | | | | | | or B18. |
| | | | | | | | | | | Select |
| | | | | | | | | | | B18 due |
| | | | | | | | | | | to higher |
| | | | | | | | | | | level. |
| b21 | 1 | B20 | WB | B16 | B32 | B24 | B20 | B22 | | B22 |
| | | | | | | | | | | overwrites |
| | | | | | | | | | | b19. |
| b23 | 2 | b21 | WB | B16 | B32 | B24 | B22 | b21 | B20 | Exclude |
| | | | | | | | | | | either B16 |
| | | | | | | | | | | or B20. |
| | | | | | | | | | | Select |
| | | | | | | | | | | B20 due |
| | | | | | | | | | | to higher |
| | | | | | | | | | | level. |
| B28 | 6 | B22 | WB | B16 | B32 | B24 | B22 | b23 | | b23 |
| | | | | | | | | | | overwrites |
| | | | | | | | | | | b21. |
| B26 | 3 | b23 | WB | B16 | B32 | B24 | b23 | B28 | B22 | Exclude |
| | | | | | | | | | | either B16 |
| | | | | | | | | | | or B22. |
| | | | | | | | | | | Select |
| | | | | | | | | | | B22 due |
| | | | | | | | | | | to higher |
| | | | | | | | | | | level. |
| b25 | 1 | B24 | WB | B16 | B32 | B24 | B28 | B26 | | B26 |
| | | | | | | | | | | overwrites |
| | | | | | | | | | | b23. |
| b27 | 2 | b25 | WB | B16 | B32 | B28 | B26 | b25 | B24 | Exclude |
| | | | | | | | | | | either B16 |
| | | | | | | | | | | or B24. |
| | | | | | | | | | | Select |
| | | | | | | | | | | B24 due |
| | | | | | | | | | | to higher |
| | | | | | | | | | | level. |
| B30 | 4 | B26 | WB | B16 | B32 | B28 | B26 | b27 | | b27 |
| | | | | | | | | | | overwrites |
| | | | | | | | | | | b25. |
| b29 | 2 | b27 | WB | B16 | B32 | B28 | b27 | B30 | B26 | Exclude |
| | | | | | | | | | | either B16 |
| | | | | | | | | | | or B26. |
| | | | | | | | | | | Select |
| | | | | | | | | | | B26 due |
| | | | | | | | | | | to higher |
| | | | | | | | | | | level. |
| b31 | 3 | B28 | WB | B16 | B32 | B28 | B30 | b29 | | b29 |
| | | | | | | | | | | overwrites |
| | | | | | | | | | | b27. |

As shown in Table 4, five reference pictures are available for inter-prediction of b5, namely IDR0, B16, B8, B4 and B6. The output delay of b5 is 1, hence it needs to be stored in the DPB for 1 picture interval. Due to DPB space limitation, at the end of b5 encoding/decoding, one of the five reference pictures need to be removed from the DPB to make space for b5. According the prior art AVC video coding scheme, a b7 cannot mark B4 as “unused as reference”, therefore B4 must be removed early by B6. As a result, number of available reference pictures for inter-prediction of b5 is reduced. On the other hand, the present invention allows B4 to be removed only at the start of b7 encoding/decoding, as described above for the first embodiment of an encoding process for a plurality of pictures S400. Therefore, the benefit of the present invention is to timely removal of B4, thereby allowing b5 to still make full use of all four reference pictures. Consequently, the coding efficiency of b5 is optimized.

Similarly to the above, the benefit of the present invention in allowing timely removal of reference picture can also be shown for encoding/decoding of b9 and b11.

As shown in Table 4, DPB is increasingly filled from IDR0 to B2 and is fully occupied at the start of b1 encoding/decoding. To encode/decode B6, one reference picture needs to be removed from the DPB at the start of B6 encoding/decoding. According to the exemplary decision process as described for Table 1 previously, B2 is excluded/removed as it is located at hierarchical level 2, as opposed to IDR0 which is located at hierarchical level 0 (as shown in FIG. 9). A similar decision and exclusion/removal process continues throughout the encoding of the plurality of pictures, where reference pictures to be excluded/removed from RPS are indicated in the respective RPS parameters written into the coded video bitstream. Such exclusion/removal process is performed according to the second embodiment S600 or third embodiment S700 of an encoding process for a plurality of pictures as described above. As shown in Column C405 of Table 4, exclusion/removal of reference pictures from RPS is performed at every other picture (i.e. performed once every two consecutive pictures in coding order).

Alternative 5-level hierarchical coding structures starting from IDR or CRA pictures with or without leading pictures can be achieved using to the same embodiments of encoding process according to the present invention.

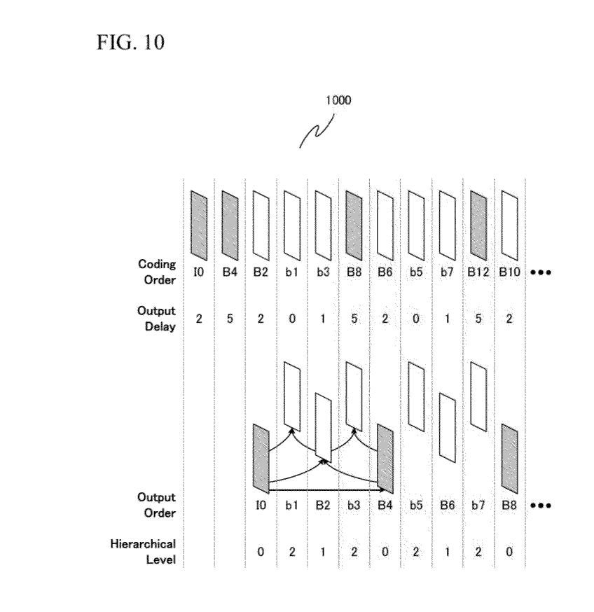

FIG. 10 and Table 5 show a hierarchical coding structure with 3 levels, which periodically repeats itself every 4 pictures. In Table 5, IDR (instantaneous decoding refresh) picture is used instead of a generic I picture, similar to Table 1. The DPB size is set such that maximum number of pictures allowed in the DPB is 4.

TABLE 5
Sequence of operations for 3-level hierarchical structure
starting from IDR picture without leading pictures

| | | (C503) | | | | | (C505) | |
|---|---|---|---|---|---|---|---|---|
| (C501) | (C502) | Picture | | | | | Exclude | |
| Target | Output | To | (C504) | | | | From | (C506) |
| Picture | Delay | Output | DPB Content | | | | RPS | Remark |
| IDR0 | 2 | — | WB | | | | | |
| B4 | 5 | — | WB | IDR0 | | | | |
| B2 | 2 | IDR0 | WB | IDR0 | B4 | | | |
| b1 | 0 | b1 | WB | IDR0 | B4 | B2 | | |
| b3 | 1 | B2 | WB | IDR0 | B4 | B2 | | |
| B8 | 5 | b3 | WB | B4 | B2 | b3 | IDR0 | Exclude |
| | | | | | | | | either B4 |
| | | | | | | | | or IDR0 |
| | | | | | | | | from RPS. |
| | | | | | | | | Select |
| | | | | | | | | IDR0 due |
| | | | | | | | | to longer |
| | | | | | | | | distance. |
| B6 | 2 | B4 | WB | B4 | B2 | B8 | | B8 |
| | | | | | | | | overwrites |
| | | | | | | | | b3. |
| b5 | 0 | b5 | WB | B4 | B8 | B6 | B2 | Exclude |
| | | | | | | | | either B4 |
| | | | | | | | | or B2 |
| | | | | | | | | from RPS. |
| | | | | | | | | Select B2 |
| | | | | | | | | due to |
| | | | | | | | | higher |
| | | | | | | | | level. |
| b7 | 1 | B6 | WB | B4 | B8 | B6 | | |

As shown in Table 5, DPB is increasingly filled from IDR0 to B2 and is fully occupied at the start of bi encoding/decoding. To encode/decode B8, one reference picture needs to be removed from the DPB at the start of 38 encoding/decoding. According to the exemplary decision process as described for Table 1 previously, IDR0 is excluded/removed as it has longer temporal distance (i.e. output order distance) from the target picture B8, as compared to B4. A similar decision and exclusion/removal process continues throughout the encoding of the plurality of pictures, where reference pictures to be excluded/removed from RPS are indicated in the respective RPS parameters written into the coded video bitstream. Such exclusion/removal process is performed according to the second embodiment S600 or third embodiment S700 of an encoding process for a plurality of pictures as described above. As shown in Column C505 of Table 5, exclusion/removal of reference pictures from RPS is performed at every other picture (i.e. performed once every two consecutive pictures in coding order).

Alternative 3-level hierarchical coding structures starting from IDR or CRA pictures with or without leading pictures can be achieved using to the same embodiments of encoding process according to the present invention.

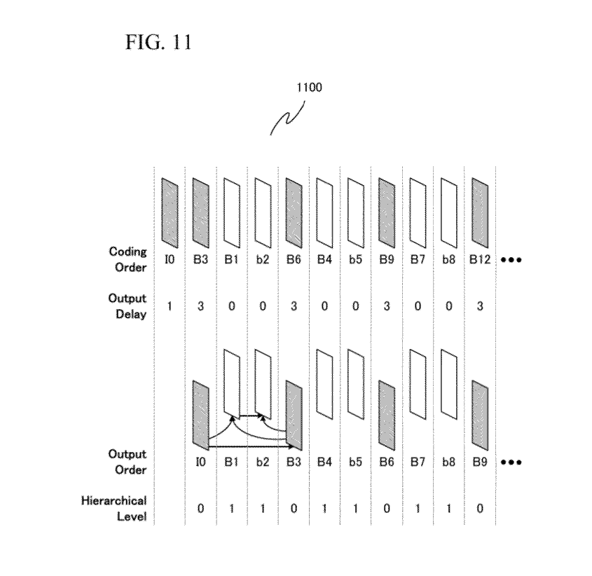

FIG. 11 and Table 6 show a first hierarchical coding structure with 2 levels, which periodically repeats itself every 3 pictures and contains 2 consecutive pictures at level 1. The first level-1 picture is a reference picture, while the second level-1 picture is a non-reference picture. In Table 6, IDR (instantaneous decoding refresh) picture is used instead of a generic I picture, similar to Table 1. The DPB size is set such that maximum number of pictures allowed in the DPB is 3.

TABLE 6
Sequence of operations for a first 2-level hierarchical structure
starting from IDR picture without leading pictures

| | | (C603) | | | | (C605) | |
|---|---|---|---|---|---|---|---|
| (C601) | (C602) | Picture | | | | Exclude | |
| Target | Output | To | (C604) | | | From | (C606) |
| Picture | Delay | Output | DPB Content | | | RPS | Remark |
| IDR0 | 1 | — | WB | | | | |
| B3 | 3 | IDR0 | WB | IDR0 | | | |
| B1 | 0 | B1 | WB | IDR0 | B3 | | |
| b2 | 0 | b2 | WB | B3 | B1 | IDR0 | Only IDR has |
| | | | | | | | passed its |
| | | | | | | | output |
| | | | | | | | instance/time. |
| B6 | 3 | B3 | WB | B3 | B1 | | |
| B4 | 0 | B4 | WB | B3 | B6 | B1 | Exclude either |
| | | | | | | | B3 or B1 from |
| | | | | | | | RPS. Select |
| | | | | | | | B1 due to |
| | | | | | | | higher level. |
| b5 | 0 | b5 | WB | B6 | B4 | B3 | Only B3 has |
| | | | | | | | passed its |
| | | | | | | | output |
| | | | | | | | instance/time. |

As shown in Table 6, DPB is increasingly filled from IDR0 to B3 and is fully occupied at the start of B1 encoding/decoding. To encode/decode b2, one reference picture needs to be removed from the DPB at the start of b2 encoding/decoding. IDR0 is removed as it is the only reference picture in DPB that has passed its output instance/time. Similarly, to encode/decode B4, one reference picture needs to be removed from the DPB at the start of B4 encoding/decoding. According to the exemplary decision process as described for Table 1 previously, B1 is excluded/removed as it is located at hierarchical level 1, as opposed to B3 which is located at hierarchical level 0 (as shown in FIG. 11). Such exclusion/removal process is performed according to the second embodiment S600 or third embodiment S700 of an encoding process for a plurality of pictures as described above. As shown in Column C605 of Table 6, exclusion/removal of reference pictures from RPS is performed at every second and third picture out of each 3-picture hierarchical interval.

Alternative 2-level hierarchical coding structures starting from IDR or CRA pictures with or without leading pictures can be achieved using to the same embodiments of encoding process according to the present invention.

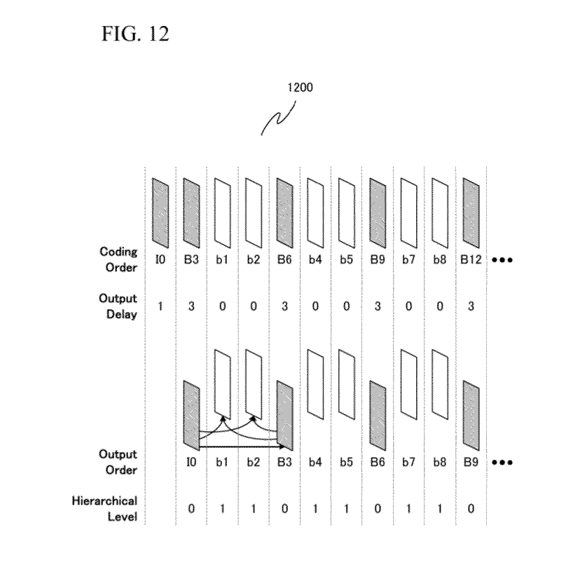

FIG. 12 and Table 7 show a second hierarchical coding structure with 2 levels, which periodically repeats itself every 3 pictures and contains 2 consecutive pictures at level 1. Both level-1 pictures are non-reference pictures. In Table 7, IDR (instantaneous decoding refresh) picture is used instead of a generic I picture, similar to Table 1. The DPB size is set such that maximum number of pictures allowed in the DPB is 3.

TABLE 7
Sequence of operations for a second 2-level hierarchical structure
starting from IDR picture without leading pictures

| | | (C703) | | | | (C705) | |
|---|---|---|---|---|---|---|---|
| (C701) | (C702) | Picture | | | | Exclude | |
| Target | Output | To | (C704) | | | From | (C706) |
| Picture | Delay | Output | DPB Content | | | RPS | Remark |
| IDR0 | 1 | — | WB | | | | |
| B3 | 3 | IDR0 | WB | IDR0 | | | |
| b1 | 0 | b1 | WB | IDR0 | B3 | | |
| b2 | 0 | b2 | WB | IDR0 | B3 | | |
| B6 | 3 | B3 | WB | IDR0 | B3 | | |
| b4 | 0 | b4 | WB | B3 | B6 | IDR0 | Exclude |
| | | | | | | | either B3 |
| | | | | | | | or IDR0 |
| | | | | | | | from RPS. |
| | | | | | | | Select |
| | | | | | | | IDR0 due |
| | | | | | | | to longer |
| | | | | | | | distance. |
| b5 | 0 | b5 | WB | B3 | B6 | | |

As shown in Table 7, DPB is increasingly filled from IDR0 to B3 and is fully occupied at the start of bi encoding/decoding. To encode/decode b4, one reference picture needs to be removed from the DPB at the start of b4 encoding/decoding so that 36 can be stored until its output instance/time. According to the exemplary decision process as described for Table 1 previously, IDR0 is excluded/removed as it has longer temporal distance (i.e. output order distance) from the target picture b4, as compared to B3. Such exclusion/removal process is performed according to the second embodiment S600 or third embodiment S700 of an encoding process for a plurality of pictures as described above. As shown in Column C705 of Table 7, exclusion/removal of reference pictures from RPS is performed at every second picture out of each 3-picture hierarchical interval.

Alternative 2-level hierarchical coding structures starting from IDR or CRA pictures with or without leading pictures can be achieved using to the same embodiments of encoding process according to the present invention.

### [Syntax]

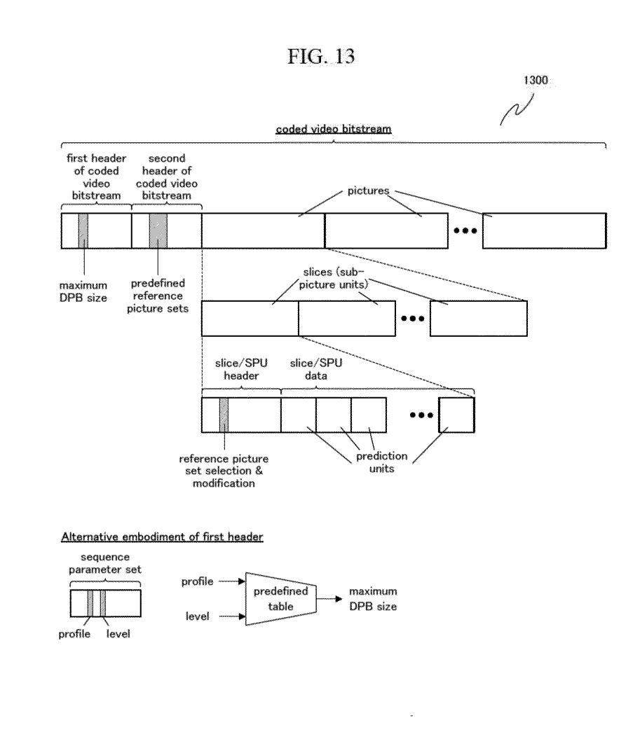

FIG. 13 is a syntax diagram which shows the location of parameters specifying the maximum DPB size and the reference picture sets.

As shown in FIG. 13, maximum DPB size parameter is located in the is first header of the coded video bitstream. One example of the first header is the sequence parameter set. In an alternative embodiment of the present invention, the maximum DPB size is derived from the profile and level parameters in the first header according to a predetermined mapping table. A second header of the coded video bitstream contains parameters specifying a plurality of predefined reference picture sets. In the slice header, one out of the plurality of predefined reference picture sets is selected and possibly modified to be used as the active reference picture set for the encoding/decoding of the slice. The active reference picture set defines a list of reference pictures. When a reference picture that is present in the DPB is excluded from the list, it is marked as “unused as reference” (i.e. set as a non-reference picture). An example of the second header is the picture parameter set. Another example of the second header is the adaptation parameter set. In an alternative embodiment of the present invention, both the maximum DPB size and predefined reference picture sets are located in the first header. Besides slices, possible embodiments of the present invention may use other sub-picture units such as tiles, entropy slices and wavefront partitioning units. In such embodiments, the parameters for selecting and modifying a reference picture set may be located in a header of the sub-picture unit.

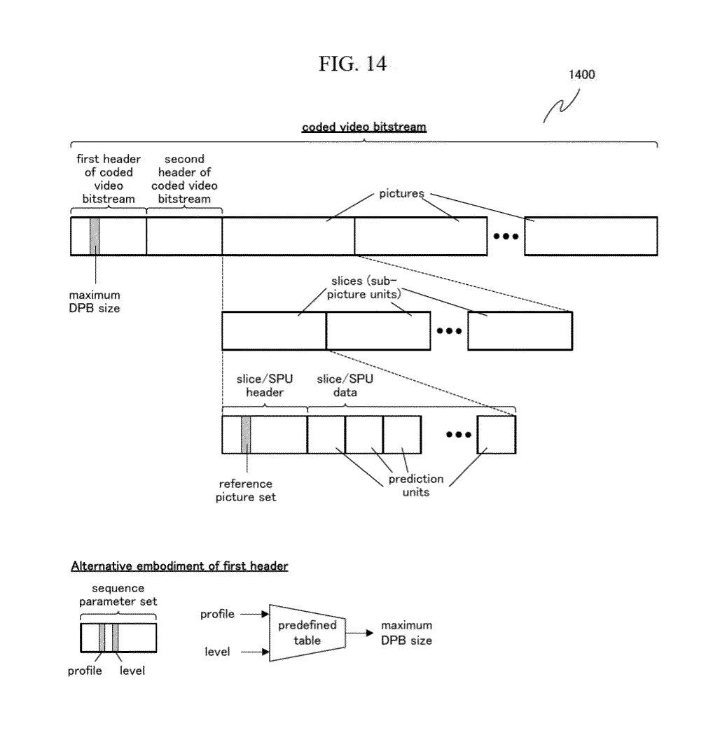

FIG. 14 is a syntax diagram which shows the location of parameters specifying the maximum DPB size and the reference picture sets.

As shown in FIG. 14, maximum DPB size parameter is located in the first header of the coded video bitstream. One example of the first header is the sequence parameter set. In an alternative embodiment of the present invention, the maximum DPB size is derived from the profile and level parameters in the first header according to a predetermined mapping table. A slice header or a header of a sub-picture unit contains the parameters for specifying the active reference picture set to be used for the encoding/decoding of the slice or sub-picture unit. The active reference picture set defines a list of reference pictures. When a reference picture that is present in the DPB is excluded from the list, it is marked as “unused as reference” (i.e. set as a non-reference picture).

### [Effect of Encoding Invention]

The effect of the present invention is in the form of improved coding efficiency of inter-predicted pictures while keeping a small memory storage size for DPB. The present invention allows timely removal of pictures from the DPB so that reference pictures are kept available as inter prediction reference as long as possible without violating the maximum DPB size restriction.

### [Decoding Apparatus]

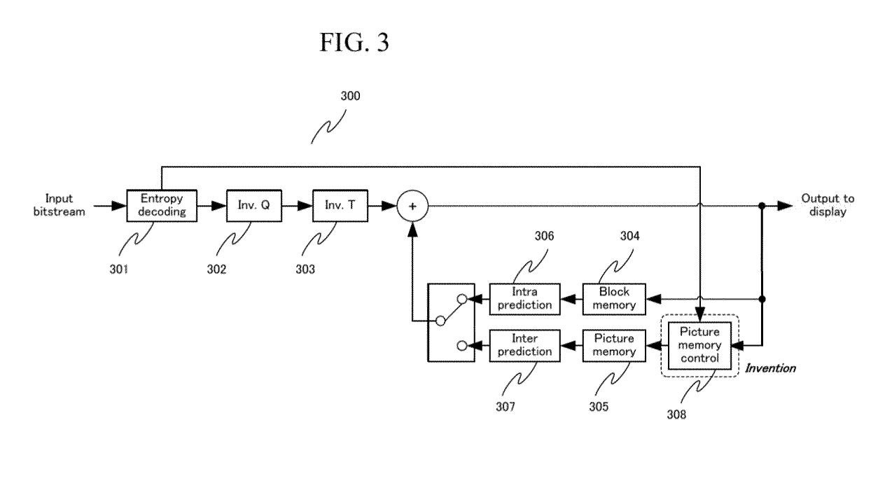

FIG. 3 is a block diagram which shows a structure of video/image decoding apparatus 300 in the present invention.

The video/image decoding apparatus 300 is an apparatus for decoding an input coded bit stream on a block-by-block basis and outputting videos/images, and comprises as shown in FIG. 3, an entropy decoding unit 301, an inverse quantization unit 302, an inverse transformation unit 303, an block memory 304, an picture memory 305, an intra prediction unit 306, an inter prediction unit 307, a picture memory control unit 308.

An input encoded bit stream is inputted to the entropy decoding unit 301. After the input encoded bit stream is inputted to the entropy decoding unit 301, the entropy decoding unit 301 decodes the input encoded bit stream, and outputs the decoded values to the inverse quantization unit 302. The inverse quantization unit 302 inversely quantizes the decoded values, and outputs the frequency coefficients to the inverse transformation unit 303. The inverse transformation unit 303 performs inverse frequency transform on the frequency coefficients to transform the frequency coefficients into sample values, and outputs the resulting pixel values to an adder. The adder adds the resulting pixel values to the predicted video/image values outputted from the intra/inter prediction unit 306, 307, and outputs the resulting values to display, and outputs the resulting values to the block memory 304 or the picture memory 305 (through the picture memory control unit 308) for further prediction. In addition, the intra/inter prediction unit 306, 307 searches within videos/images stored in the block memory 304 or picture memory 305, and estimates a video/image area which is e.g. most similar to the decoded videos/images for prediction.

The picture memory control unit 308 manages the reconstructed pictures stored in the picture memory 305. It reads the control parameters from the entropy decoding unit 301 and performs memory management processes accordingly. The memory management processes performed by the picture memory control unit 308 comprises determining based on parsed parameters whether a reconstructed picture is kept or removed from the picture memory 305, and constructing reference picture set to be used by the inter prediction unit 307.

### [Decoding Process]

Next, a description is given as to the operations of the video/image decoding apparatus 300 as mentioned above.

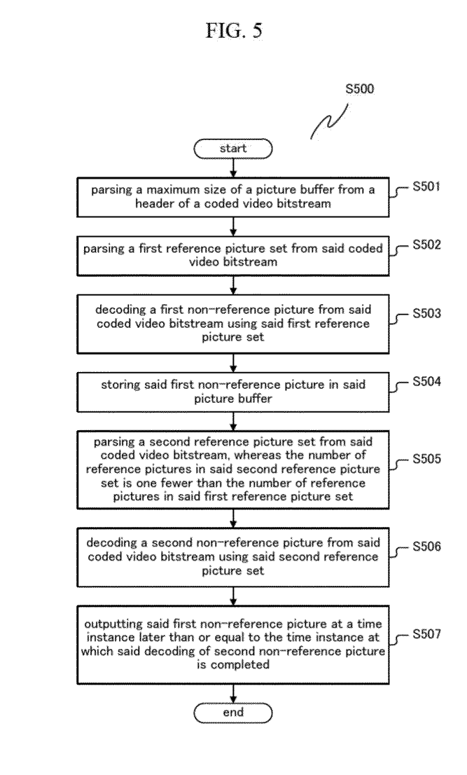

FIG. 5 is a flowchart which shows a first embodiment of an decoding process for a plurality of pictures S500 as performed by the video/image encoding apparatus 300 according to the present invention.

Step S501 parses a maximum size of a picture buffer from a header of a coded video bitstream. The maximum size determines the maximum number of pictures that are allowed (i.e. can be stored) in the picture buffer. Next, Step S502 parses a first reference picture set from the coded video bitstream, whereas the number of reference pictures in the first reference picture set is one fewer than the maximum number of pictures allowed in the picture buffer. Step S503 then decodes a first non-reference picture from the coded video bitstream using the first reference picture set. Step S504 stores the first non-reference picture in the picture buffer.

Next, Step S505 parses a second reference picture set from the coded video bitstream, whereas the number of reference pictures in the second reference picture set is one fewer than the number of reference pictures in the first reference picture set. Step S506 then decodes a second non-reference picture from the coded video bitstream using the second reference picture set. Finally, Step S507 outputs the first non-reference picture at a time instance later than or equal to the time instance at which the decoding of second non-reference picture is completed.

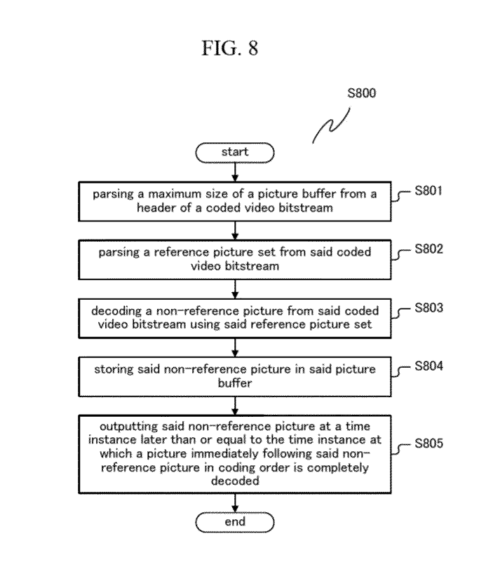

FIG. 8 is a flowchart which shows a second embodiment of an decoding process for a plurality of pictures S800 as performed by the video/image decoding apparatus 300 according to the present invention.

Step S801 parses a maximum size of a picture buffer from a header of a coded video bitstream. The maximum size determines the maximum number of pictures that are allowed (i.e. can be stored) in the picture buffer. Next, Step S802 parses a reference picture set from the coded video bitstream. Step S803 then decodes a non-reference picture from the coded video bitstream using the reference picture set. Step S804 stores the non-reference picture in the picture buffer. Finally, Step S805 outputs the non-reference picture at a time instance later than or equal to the time instance at which a picture immediately following the non-reference picture in coding order is completely decoded.

### [Effect of Decoding Invention]

The effect of the present disclosure is to enable the decoding of a coded video bitstream which is coded in the form of improved coding efficiency of inter-predicted pictures while keeping a small memory storage size for DPB.

### Exemplary Applications of the Embodiments

The processing described in each of embodiments can be simply implemented in an independent computer system, by recording, in a recording medium, a program for implementing the configurations of the moving picture coding method (image coding method) and the moving picture decoding method (image decoding method) described in each of embodiments. The recording media may be any recording media as long as the program can be recorded, such as a magnetic disk, an optical disk, a magnetic optical disk, an IC card, and a semiconductor memory.

Hereinafter, the applications to the moving picture coding method (image coding method) and the moving picture decoding method (image decoding method) described in each of embodiments and systems using thereof will be described. The system has a feature of having an image coding and decoding apparatus that includes an image coding apparatus using the image coding method and an image decoding apparatus using the image decoding method. Other configurations in the system can be changed as appropriate depending on the cases.

### [Exemplary Application A]

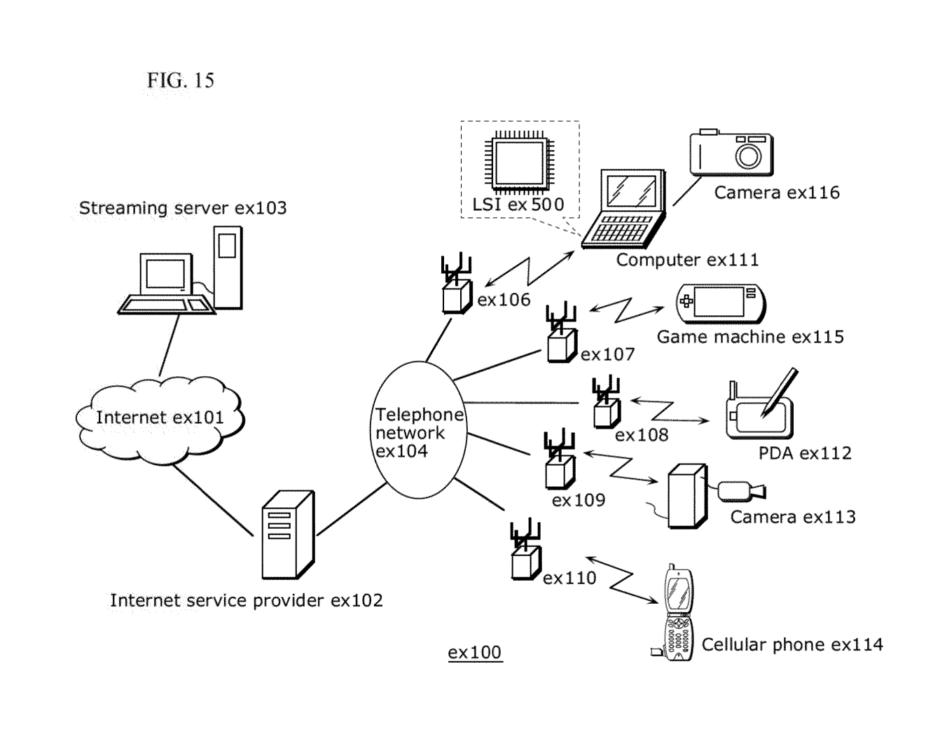

FIG. 15 illustrates an overall configuration of a content providing system ex100 for implementing content distribution services. The area for providing communication services is divided into cells of desired size, and base stations ex106, ex107, ex108, ex109, and ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex104, as well as the base stations ex106 to ex110, respectively.

However, the configuration of the content providing system ex100 is not limited to the configuration shown in FIG. 15, and a combination in which any of the elements are connected is acceptable. In addition, each device may be directly connected to the telephone network ex104, rather than via the base stations ex106 to ex110 which are the fixed wireless stations. Furthermore, the devices may be interconnected to each other via a short, distance wireless communication and others.

The camera ex113, such as a digital video camera, is capable of capturing video. A camera ex116, such as a digital camera, is capable of capturing both still images and video. Furthermore, the cellular phone ex114 may be the one that meets any of the standards such as Global System for Mobile Communications (GSM) (registered trademark), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. In such a distribution, a content (for example, video of a music live show) captured by the user using the camera ex113 is coded as described above in each of embodiments (i.e., the camera functions as the image coding apparatus according to an aspect of the present disclosure), and the coded content is transmitted to the streaming server ex103. On the other hand, the streaming server ex103 carries out stream distribution of the transmitted content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data (i.e., functions as the image decoding apparatus according to an aspect of the present disclosure).

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and video captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be conFIG.d of a single chip or a plurality of chips. Software for coding and decoding video may be integrated into some type of a recording medium (such as a CD-ROM, a flexible disk, and a hard disk) that is readable by the computer ex111 and others, and the coding and decoding processes may be performed using the software. Furthermore, when the cellular phone ex114 is equipped with a camera, the video data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients may receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

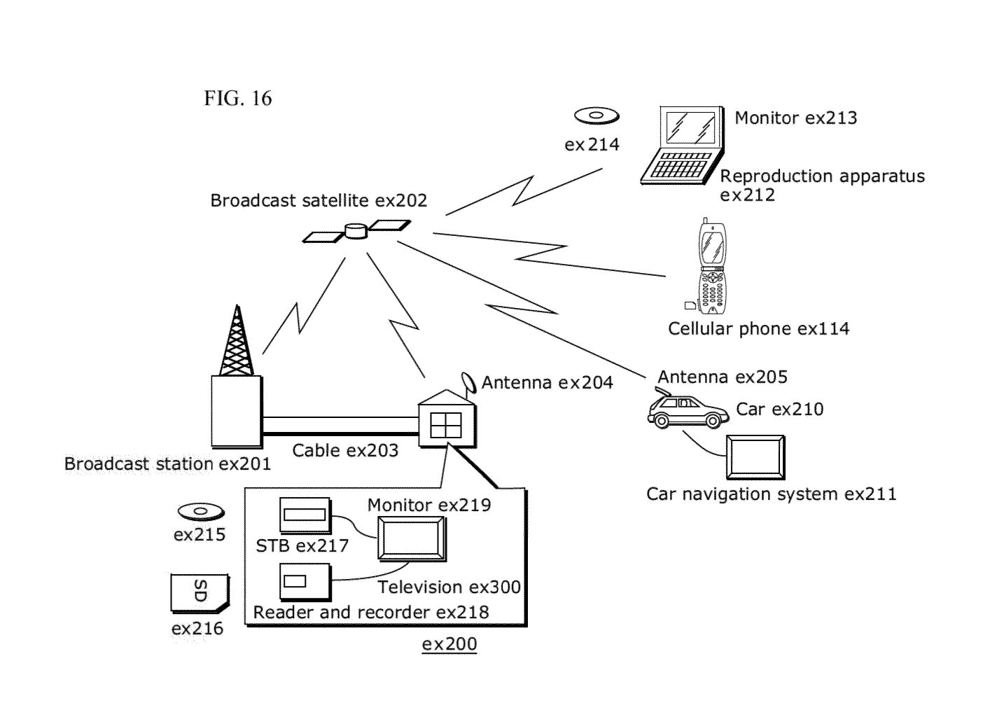

Aside from the example of the content providing system ex100, least one of the moving picture coding apparatus (image coding apparatus) and the moving picture decoding apparatus (image decoding apparatus) described in each of embodiments may be implemented in a digital broadcasting system ex200 illustrated in FIG. 16. More specifically, a broadcast station ex201 communicates or transmits, via radio waves to a broadcast satellite ex202, multiplexed data obtained by multiplexing audio data and others onto video data. The video data is data coded by the moving picture coding method described in each of embodiments (i.e., data coded by the image coding apparatus according to an aspect of the present disclosure). Upon receipt of the multiplexed data, the broadcast satellite ex202 transmits radio waves for broadcasting. Then, a home-use antenna ex204 with a satellite broadcast reception function receives the radio waves. Next, a device such as a television (receiver) ex300 and a set top box (STB) ex217 decodes the received multiplexed data, and reproduces the decoded data (i.e., functions as the image decoding apparatus according to an aspect of the present disclosure).

Furthermore, a reader/recorder ex218 (i) reads and decodes the multiplexed data recorded on a recording medium ex215, such as a DVD and a BD, or (i) codes video signals in the recording medium ex215, and in some cases, writes data obtained by multiplexing an audio signal on the coded data. The reader/recorder ex218 can include the moving picture decoding apparatus or the moving picture coding apparatus as shown in each of embodiments. In this case, the reproduced video signals are displayed on the monitor ex219, and can be reproduced by another device or system using the recording medium ex215 on which the multiplexed data is recorded. It is also possible to implement the moving picture decoding apparatus in the set top box ex217 connected to the cable ex203 for a cable television or to the antenna ex204 for satellite and/or terrestrial broadcasting, so as to display the video signals on the monitor ex219 of the television ex300. The moving picture decoding apparatus may be implemented not in the set top box but in the television ex300.

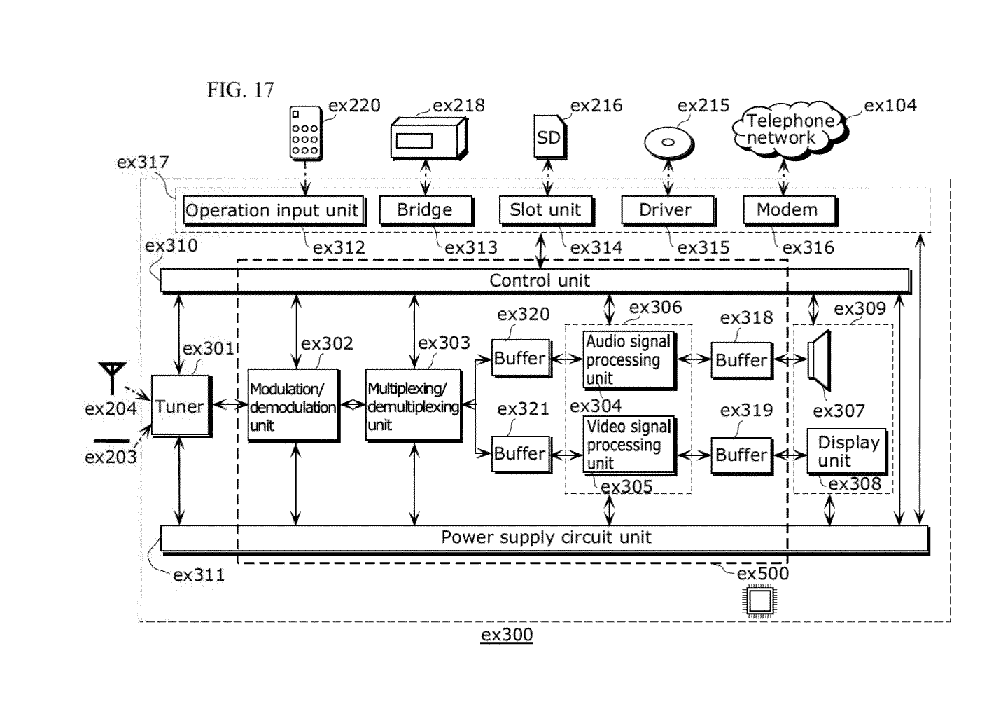

FIG. 17 illustrates the television (receiver) ex300 that uses the moving picture coding method and the moving picture decoding method described in each of embodiments. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data coded by a signal processing unit ex306 into data.

The television ex300 further includes: a signal processing unit ex306 including an audio signal processing unit ex304 and a video signal processing unit ex305 that decode audio data and video data and code audio data and video data, respectively (which function as the image coding apparatus and the image decoding apparatus according to the aspects of the present disclosure); and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, the configuration in which the television ex300 decodes multiplexed data obtained from outside through the antenna ex204 and others and reproduces the decoded data will be described. In the television ex300, upon a user operation through a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read multiplexed data not through a broadcast and others but from the recording media ex215 and ex216, such as a magnetic disk, an optical disk, and a SD card. Next, a configuration in which the television ex300 codes an audio signal and a video signal, and transmits the data outside or writes the data on a recording medium will be described. In the television ex300, upon a user operation through the remote controller ex220 and others, the audio signal processing unit ex304 codes an audio signal, and the video signal processing unit ex305 codes a video signal, under control of the control unit ex310 using the coding method described in each of embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, data may be stored in a buffer so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be capable of only receiving, decoding, and providing outside data but not the coding, multiplexing, and providing outside data.

Furthermore, when the reader/recorder ex218 reads or writes multiplexed data from or on a recording medium, one of the television ex300 and the reader/recorder ex218 may decode or code the multiplexed data, and the television ex300 and the reader/recorder ex218 may share the decoding or coding.

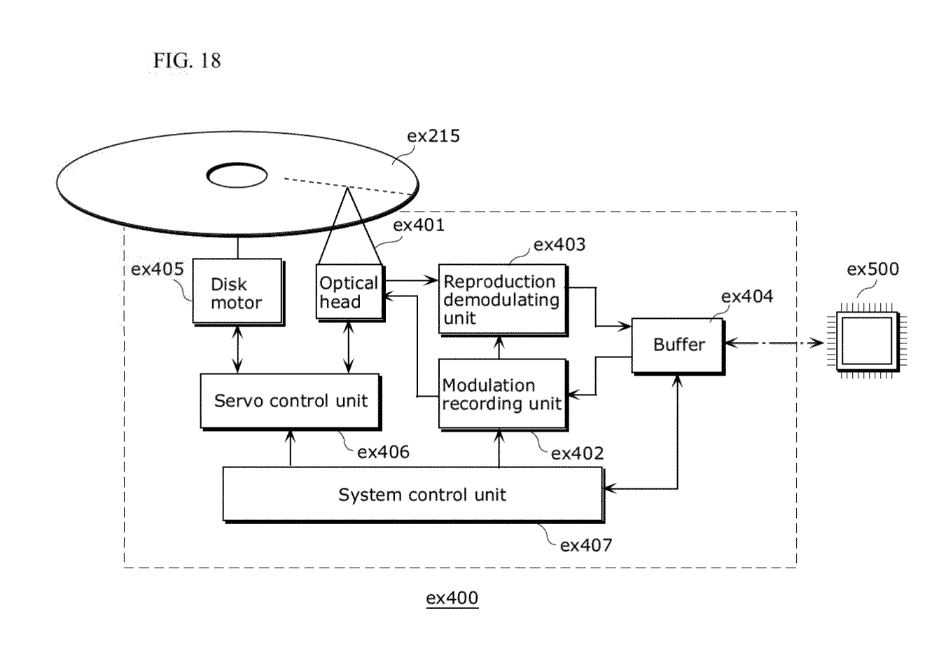

As an example, FIG. 18 illustrates a configuration of an information reproducing/recording unit ex400 when data is read or written from or on an optical disk. The information reproducing/recording unit ex400 includes constituent elements ex401, ex402, ex403, ex404, ex405, ex406, and ex407 to be described hereinafter. The optical head ex401 irradiates a laser spot in a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401 and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. The disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

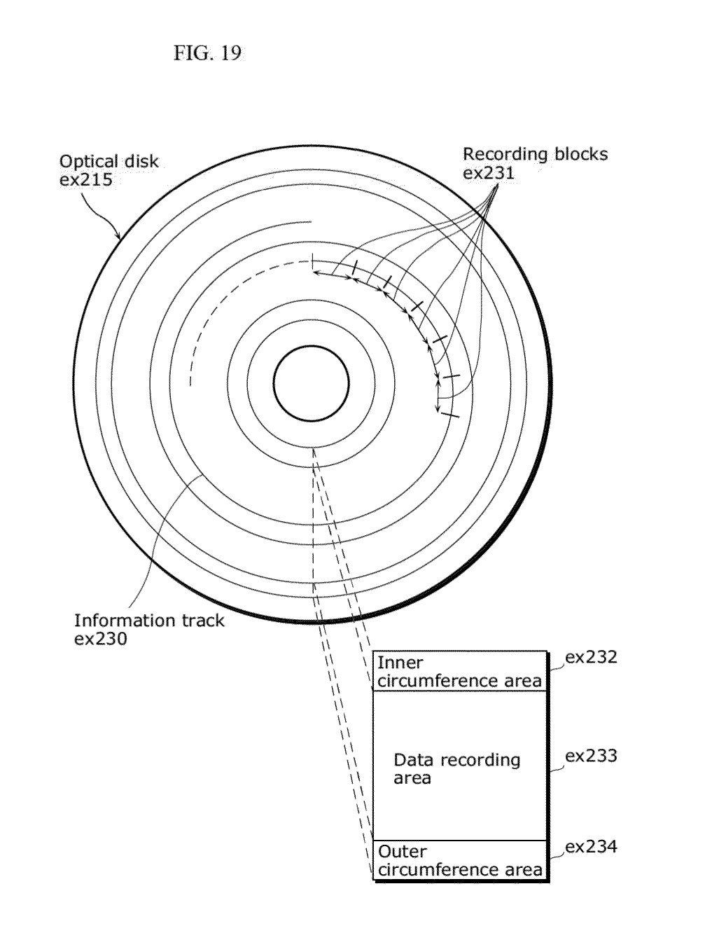

FIG. 19 illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio, coded video data, or multiplexed data obtained by multiplexing the coded audio and video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and for recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be a configuration, for example, including a GPS receiving unit from the configuration illustrated in FIG. 17. The same will be true for the configuration of the computer ex111, the cellular phone ex 114, and others.

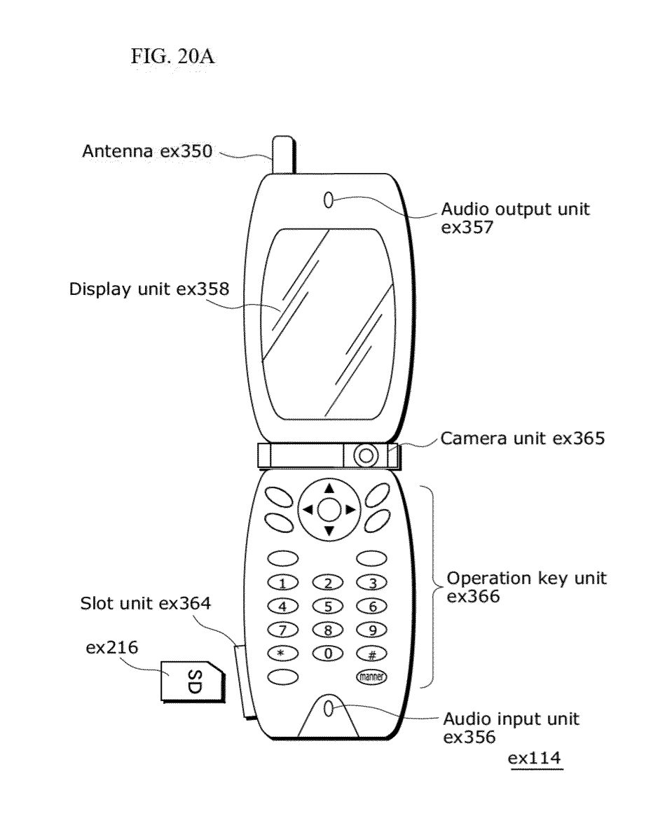

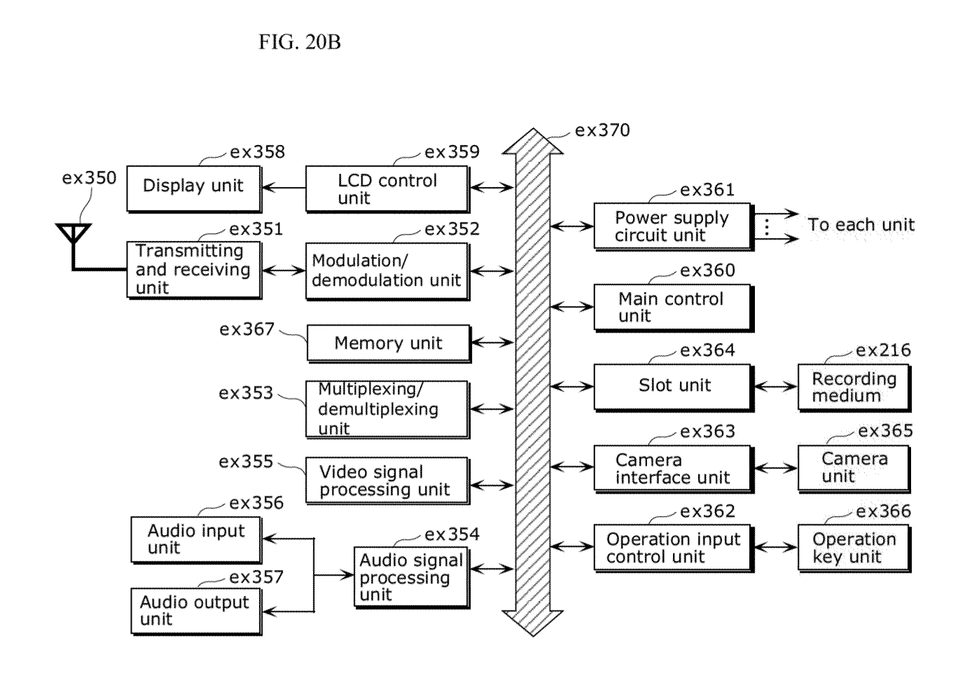

FIG. 20A illustrates the cellular phone ex114 that uses the moving picture coding method and the moving picture decoding method described in embodiments. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including an operation key unit ex366; an audio output unit ex357 such as a speaker for output of audio; an audio input unit ex356 such as a microphone for input of audio; a memory unit ex367 for storing captured video or still pictures, recorded audio, coded or decoded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 20B. In the cellular phone ex114, a main control unit ex360 designed to control overall each unit of the main body including the display unit ex358 as well as the operation key unit ex366 is connected mutually, via a synchronous bus ex370, to a power supply circuit unit ex361, an operation input control unit ex362, a video signal processing unit ex355, a camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key or a power key is turned ON by a user's operation, the power supply circuit unit ex361 supplies the respective units with power from a battery pack so as to activate the cell phone ex114.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350. Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex357.

Furthermore, when an e-mail in data communication mode is transmitted, text data of the e-mail inputted by operating the operation key unit ex366 and others of the main body is sent out to the main control unit ex360 via the operation input control unit ex362. The main control unit ex360 causes the modulation/demodulation unit ex352 to perform spread spectrum processing on the text data, and the transmitting and receiving unit ex351 performs the digital-to-analog conversion and the frequency conversion on the resulting data to transmit the data to the base station ex110 via the antenna ex350. When an e-mail is received, processing that is approximately inverse to the processing for transmitting an e-mail is performed on the received data, and the resulting data is provided to the display unit ex358.

When video, still images, or video and audio in data communication mode is or are transmitted, the video signal processing unit ex355 compresses and codes video signals supplied from the camera unit ex365 using the moving picture coding method shown in each of embodiments (i.e., functions as the image coding apparatus according to the aspect of the present disclosure), and transmits the coded video data to the multiplexing/demultiplexing unit ex353. In contrast, during when the camera unit ex365 captures video, still images, and others, the audio signal processing unit ex354 codes audio signals collected by the audio input unit ex356, and transmits the coded audio data to the multiplexing/demultiplexing unit ex353.

The multiplexing/demultiplexing unit ex353 multiplexes the coded video data supplied from the video signal processing unit ex355 and the coded audio data supplied from the audio signal processing unit ex354, using a predetermined method. Then, the modulation/demodulation unit (modulation/demodulation circuit unit) ex352 performs spread spectrum processing on the multiplexed data, and the transmitting and receiving unit ex351 performs digital-to-analog conversion and frequency conversion on the data so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bit stream and an audio data bit stream, and supplies the video signal processing unit ex355 with the coded video data and the audio signal processing unit ex354 with the coded audio data, through the synchronous bus ex370. The video signal processing unit ex355 decodes the video signal using a moving picture decoding method corresponding to the moving picture coding method shown in each of embodiments (i.e., functions as the image decoding apparatus according to the aspect of the present disclosure), and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, it is possible for a terminal such as the cellular phone ex114 to have 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the moving picture coding method and the moving picture decoding method in each of embodiments can be used in any of the devices and systems described. Thus, the advantages described in each of embodiments can be obtained.

Furthermore, various modifications and revisions can be made in any of the embodiments in the present disclosure.

### [Exemplary Application B]

Video data can be generated by switching, as necessary, between (i) the moving picture coding method or the moving picture coding apparatus shown in each of embodiments and (ii) a moving picture coding method or a moving picture coding apparatus in conformity with a different standard, such as MPEG-2, MPEG-4 AVC, and VC-1.

Here, when a plurality of video data that conforms to the different standards is generated and is then decoded, the decoding methods need to be selected to conform to the different standards. However, since the standard to which each of the plurality of the video data to be decoded conforms cannot be detected, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the moving picture coding method and by the moving picture coding apparatus shown in each of embodiments will be hereinafter described. The multiplexed data is a digital stream in the MPEG-2 Transport Stream format.

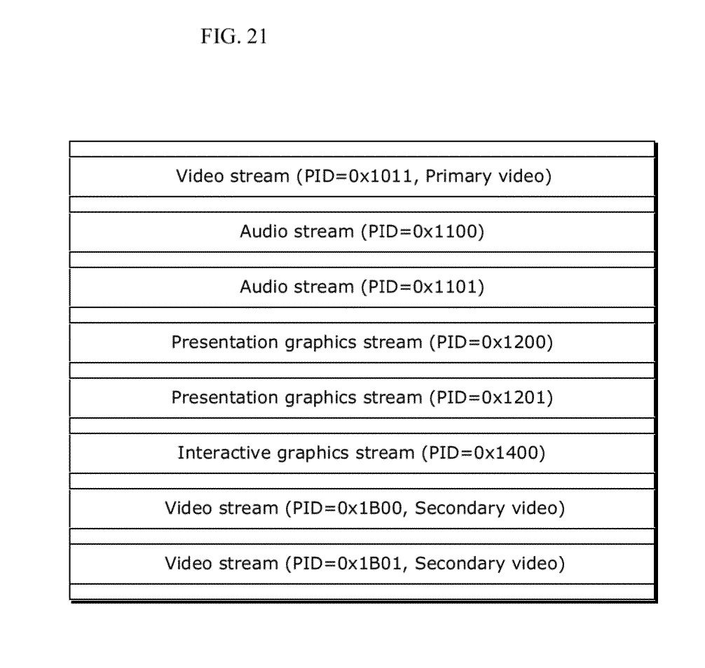

FIG. 21 illustrates a structure of the multiplexed data. As illustrated in FIG. 21, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of the movie. Here, the primary video is normal video to be displayed on a screen, and the secondary video is video to be displayed on a smaller window in the primary video. Furthermore, the interactive graphics stream represents an interactive screen to be generated by arranging the GUI components on a screen. The video stream is coded in the moving picture coding method or by the moving picture coding apparatus shown in each of embodiments, or in a moving picture coding method or by a moving picture coding apparatus in conformity with a conventional standard, such as MPEG-2, MPEG-4 AVC, and VC-1. The audio stream is coded in accordance with a standard, such as Dolby-AC-3, Dolby Digital Plus, MLP, DTS, DTS-HD, and linear PCM.

Each stream included in the multiplexed data is identified by PID. For example, 0x1011 is allocated to the video stream to be used for video of a movie, 0x1100 to 0x111F are allocated to the audio streams, 0x1200 to 0x121F are allocated to the presentation graphics streams, 0x1400 to 0x141F are allocated to the interactive graphics streams, 0x1B00 to 0x1B1F are allocated to the video streams to be used for secondary video of the movie, and 0x1A00 to 0x1A1F are allocated to the audio streams to be used for the secondary audio to be mixed with the primary audio.

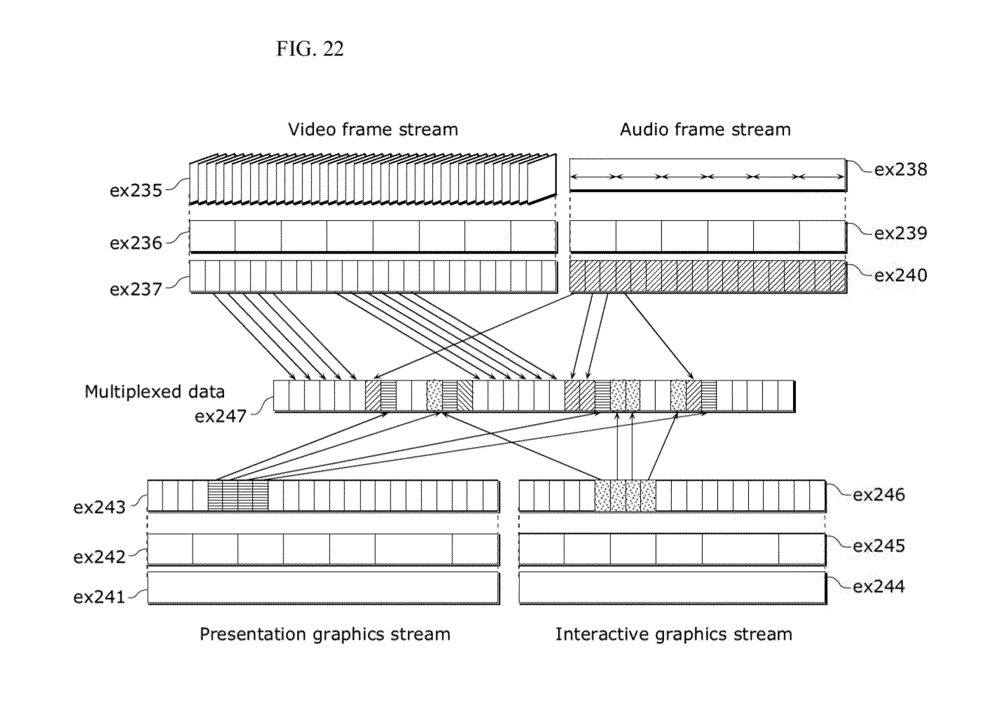

FIG. 22 schematically illustrates how data is multiplexed. First, a video stream ex235 composed of video frames and an audio stream ex238 composed of audio frames are transformed into a stream of PES packets ex236 and a stream of PES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

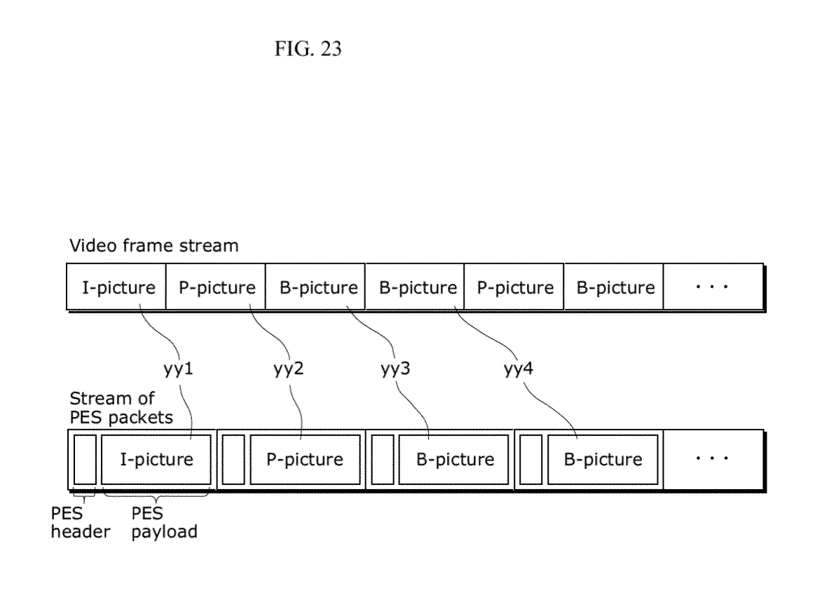

FIG. 23 illustrates how a video stream is stored in a stream of PES packets in more detail. The first bar in FIG. 23 shows a video frame stream in a video stream. The second bar shows the stream of PES packets. As indicated by arrows denoted as yy1, yy2, yy3, and yy4 in FIG. 23, the video stream is divided into pictures as I pictures, B pictures, and P pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

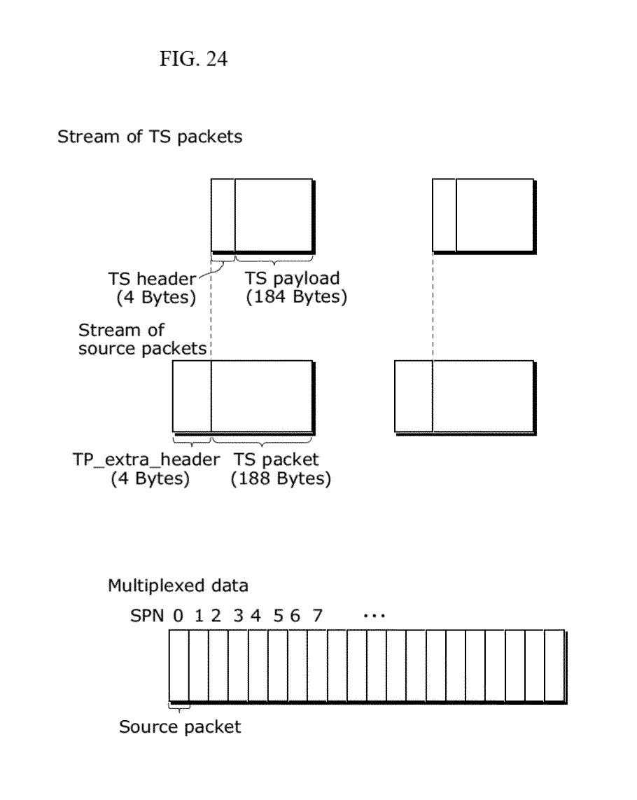

FIG. 24 illustrates a format of TS packets to be finally written on the multiplexed data. Each of the TS packets is a 188-byte fixed length packet including a 4-byte TS header having information, such as a PID for identifying a stream and a 184-byte TS payload for storing data. The PES packets are divided, and stored in the TS payloads, respectively. When a BD ROM is used, each of the TS packets is given a 4-byte TP_Extra_Header, thus resulting in 192-byte source packets. The source packets are written on the multiplexed data. The TP_Extra_Header stores information such as an Arrival_Time_Stamp (ATS). The ATS shows a transfer start time at which each of the TS packets is to be transferred to a PID filter. The source packets are arranged in the multiplexed data as shown at the bottom of FIG. 24. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information of the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

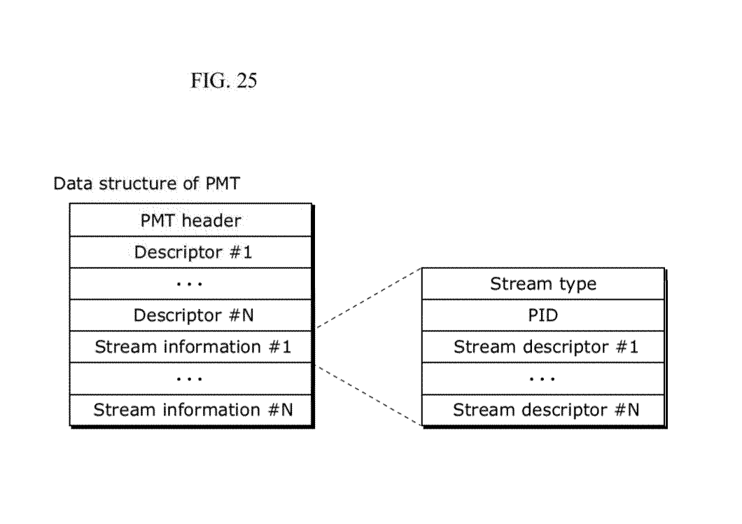

FIG. 25 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data.

When the multiplexed data is recorded on a recording medium and others, it is recorded together with multiplexed data information files.

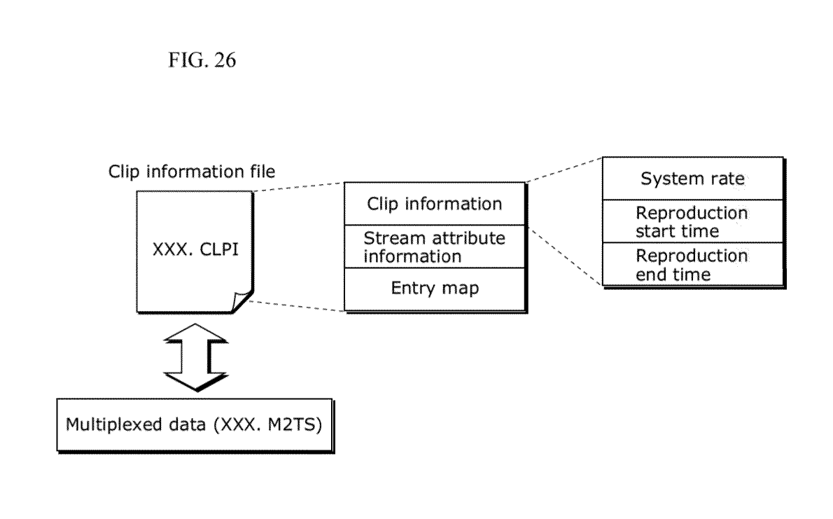

Each of the multiplexed data information files is management information of the multiplexed data as shown in FIG. 26. The multiplexed data information files are in one to one correspondence with the multiplexed data, and each of the files includes multiplexed data information, stream attribute information, and an entry map.

As illustrated in FIG. 26, the multiplexed data information includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

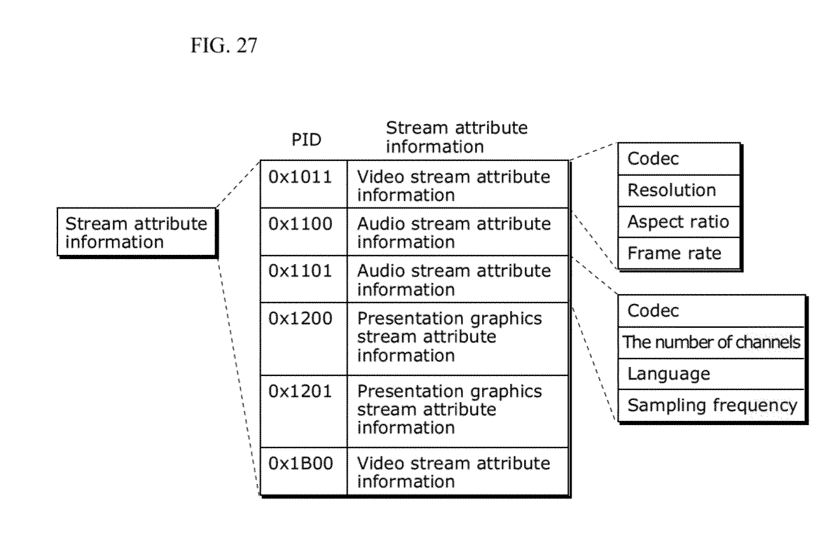

As shown in FIG. 27, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information including what kind of compression codec is used for compressing the audio stream, how many channels are included in the audio stream, which language the audio stream supports, and how high the sampling frequency is. The video stream attribute information and the audio stream attribute information are used for initialization of a decoder before the player plays back the information.

In the present embodiment, the multiplexed data to be used is of a stream type included in the PMT. Furthermore, when the multiplexed data is recorded on a recording medium, the video stream attribute information included in the multiplexed data information is used. More specifically, the moving picture coding method or the moving picture coding apparatus described in each of embodiments includes a step or a unit for allocating unique information indicating video data generated by the moving picture coding method or the moving picture coding apparatus in each of embodiments, to the stream type included in the PMT or the video stream attribute information. With the configuration, the video data generated by the moving picture coding method or the moving picture coding apparatus described in each of embodiments can be distinguished from video data that conforms to another standard.

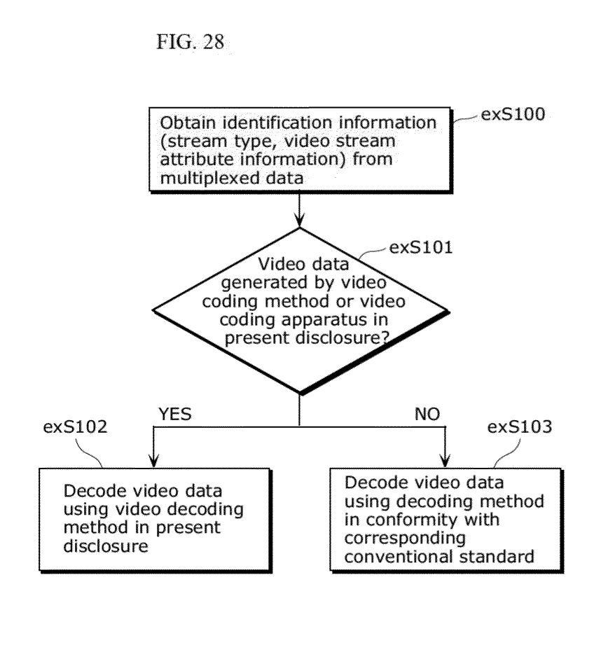

Furthermore, FIG. 28 illustrates steps of the moving picture decoding method according to the present embodiment. In Step exS100, the stream type included in the PMT or the video stream attribute information included in the multiplexed data information is obtained from the multiplexed data. Next, in Step exS101, it is determined whether or not the stream type or the video stream attribute information indicates that the multiplexed data is generated by the moving picture coding method or the moving picture coding apparatus in each of embodiments. When it is determined that the stream type or the video stream attribute information indicates that the multiplexed data is generated by the moving picture coding method or the moving picture coding apparatus in each of embodiments, in Step exS102, decoding is performed by the moving picture decoding method in each of embodiments. Furthermore, when the stream type or the video stream attribute information indicates conformance to the conventional standards, such as MPEG-2, MPEG-4 AVC, and VC-1, in Step exS103, decoding is performed by a moving picture decoding method in conformity with the conventional standards.

As such, allocating a new unique value to the stream type or the video stream attribute information enables determination whether or not the moving picture decoding method or the moving picture decoding apparatus that is described in each of embodiments can perform decoding. Even when multiplexed data that conforms to a different standard is input, an appropriate decoding method or apparatus can be selected. Thus, it becomes possible to decode information without any error. Furthermore, the moving picture coding method or apparatus, or the moving picture decoding method or apparatus in the present embodiment can be used in the devices and systems described above.

### [Exemplary Application C]

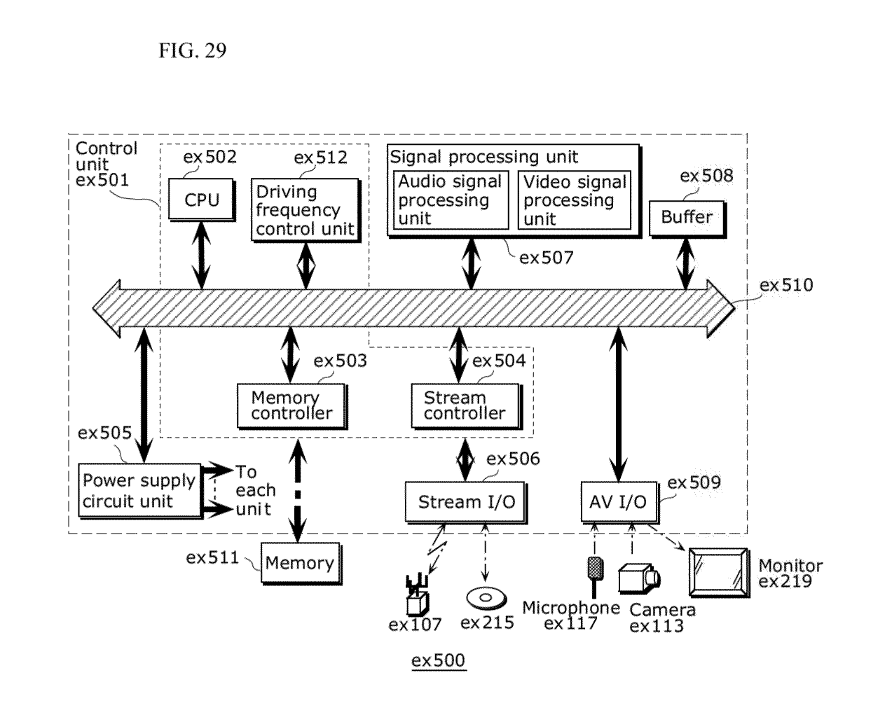

Each of the moving picture coding method, the moving picture coding apparatus, the moving picture decoding method, and the moving picture decoding apparatus in each of embodiments is typically achieved in the form of an integrated circuit or a Large Scale Integrated (LSI) circuit. As an example of the LSI, FIG. 29 illustrates a configuration of the LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when coding is performed, the LSI ex500 receives an AV signal from a microphone ex117, a camera ex113, and others through an AV IO ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the processing amount and speed to be transmitted to a signal processing unit ex507. Then, the signal processing unit ex507 codes an audio signal and/or a video signal. Here, the coding of the video signal is the coding described in each of embodiments. Furthermore, the signal processing unit ex507 sometimes multiplexes the coded audio data and the coded video data, and a stream IO ex506 provides the multiplexed data outside. The provided multiplexed data is transmitted to the base station ex107, or written on the recording medium ex215. When data sets are multiplexed, the data should be temporarily stored in the buffer ex508 so that the data sets are synchronized with each other.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

Furthermore, although the control unit ex501 includes the CPU ex502, the memory controller ex503, the stream controller ex504, the driving frequency control unit ex512, the configuration of the control unit ex501 is not limited to such. For example, the signal processing unit ex507 may further include a CPU. Inclusion of another CPU in the signal processing unit ex507 can improve the processing speed. Furthermore, as another example, the CPU ex502 may serve as or be a part of the signal processing unit ex507, and, for example, may include an audio signal processing unit. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose. Such a programmable logic device can typically execute the moving picture coding method and/or the moving picture decoding method according to any of the above embodiments, by loading or reading from a memory or the like one or more programs that are included in software or firmware.

In the future, with advancement in semiconductor technology, a brand-new technology may replace LSI. The functional blocks can be integrated using such a technology. The possibility is that the present disclosure is applied to biotechnology.

### [Exemplary Application D]

When video data generated in the moving picture coding method or by the moving picture coding apparatus described in each of embodiments is decoded, it is possible for the processing amount to increase compared to when video data that conforms to a conventional standard, such as MPEG-2, MPEG-4 AVC, and VC-1 is decoded. Thus, the LSI ex500 needs to be set to a driving frequency higher than that of the CPU ex502 to be used when video data in conformity with the conventional standard is decoded. However, when the driving frequency is set higher, there is a problem that the power consumption increases.

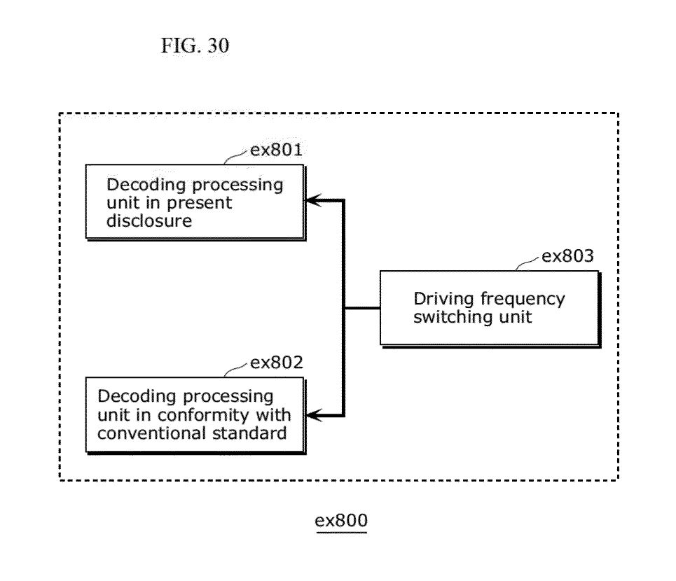

In order to solve the problem, the moving picture decoding apparatus, such as the television ex300 and the LSI ex500 is conFIG.d to determine to which standard the video data conforms, and switch between the driving frequencies according to the determined standard. FIG. 30 illustrates a configuration ex800 in the present embodiment. A driving frequency switching unit ex803 sets a driving frequency to a higher driving frequency when video data is generated by the moving picture coding method or the moving picture coding apparatus described in each of embodiments. Then, the driving frequency switching unit ex803 instructs a decoding processing unit ex801 that executes the moving picture decoding method described in each of embodiments to decode the video data. When the video data conforms to the conventional standard, the driving frequency switching unit ex803 sets a driving frequency to a lower driving frequency than that of the video data generated by the moving picture coding method or the moving picture coding apparatus described in each of embodiments. Then, the driving frequency switching unit ex803 instructs the decoding processing unit ex802 that conforms to the conventional standard to decode the video data.

More specifically, the driving frequency switching unit ex803 includes the CPU ex502 and the driving frequency control unit ex512 in FIG. 29. Here, each of the decoding processing unit ex801 that executes the moving picture decoding method described in each of embodiments and the decoding processing unit ex802 that conforms to the conventional standard corresponds to the signal processing unit ex507 in FIG. 29. The CPU ex502 determines to which standard the video data conforms. Then, the driving frequency control unit ex512 determines a driving frequency based on a signal from the CPU ex502. Furthermore, the signal processing unit ex507 decodes the video data based on the signal from the CPU ex502. For example, it is possible that the identification information described in Embodiment B is used for identifying the video data. The identification information is not limited to the one described in Embodiment B but may be any information as long as the information indicates to which standard the video data conforms. For example, when which standard video data conforms to can be determined based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 127. The driving frequency can be selected by storing the look-up table in the buffer ex508 and in an internal memory of an LSI, and with reference to the look-up table by the CPU ex502.

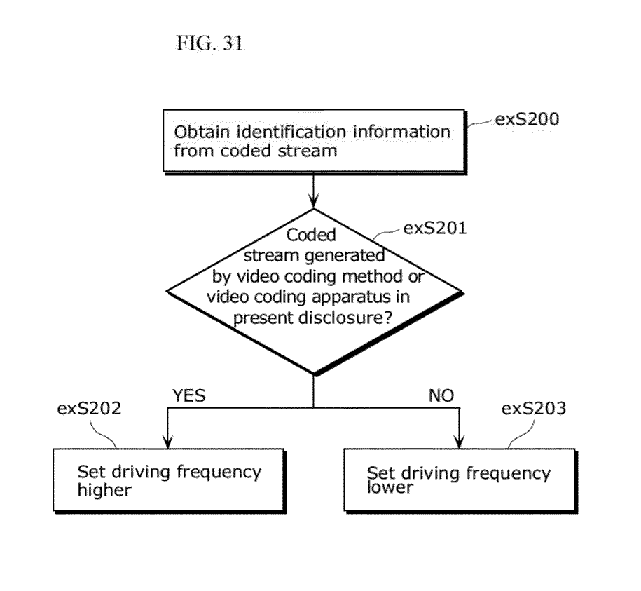

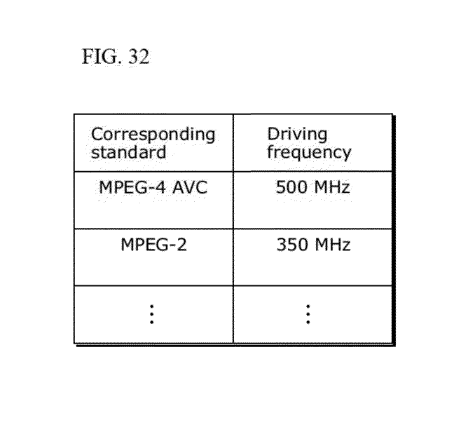

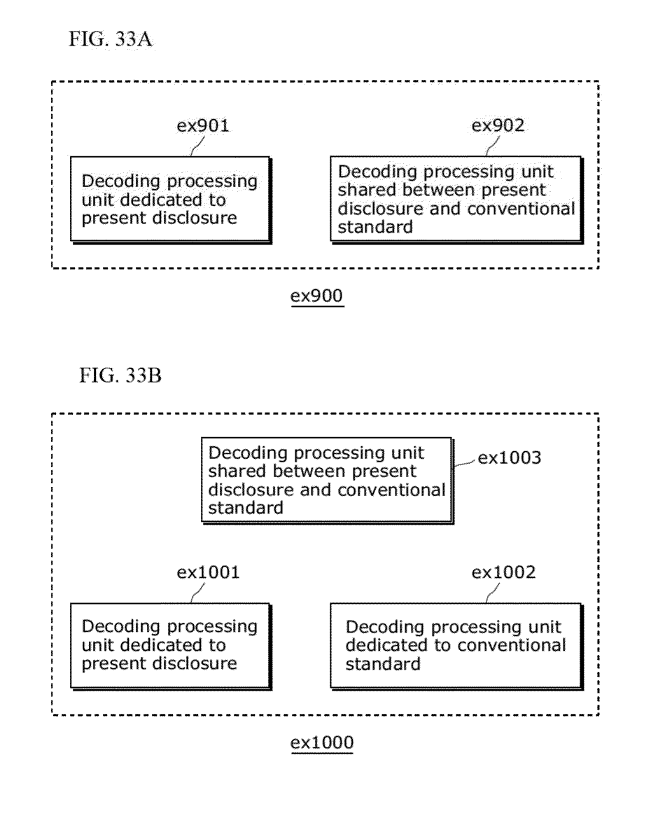

FIG. 31 illustrates steps for executing a method in the present embodiment. First, in Step exS200, the signal processing unit ex507 obtains identification information from the multiplexed data. Next, in Step exS201, the CPU ex502 determines whether or not the video data is generated by the coding method and the coding apparatus described in each of embodiments, based on the identification information. When the video data is generated by the moving picture coding method and the moving picture coding apparatus described in each of embodiments, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, MPEG-4 AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the moving picture coding method and the moving picture coding apparatus described in each of embodiment.

Furthermore, along with the switching of the driving frequencies, the power conservation effect can be improved by changing the voltage to be applied to the LSI ex500 or an apparatus including the LSI ex500. For example, when the driving frequency is set lower, it is possible that the voltage to be applied to the LSI ex500 or the apparatus including the LSI ex500 is set to a voltage lower than that in the case where the driving frequency is set higher.

Furthermore, when the processing amount for decoding is larger, the driving frequency may be set higher, and when the processing amount for decoding is smaller, the driving frequency may be set lower as the method for setting the driving frequency. Thus, the setting method is not limited to the ones described above. For example, when the processing amount for decoding video data in conformity with MPEG-4 AVC is larger than the processing amount for decoding video data generated by the moving picture coding method and the moving picture coding apparatus described in each of embodiments, it is possible that the driving frequency is set in reverse order to the setting described above.

Furthermore, the method for setting the driving frequency is not limited to the method for setting the driving frequency lower. For example, when the identification information indicates that the video data is generated by the moving picture coding method and the moving picture coding apparatus described in each of embodiments, it is possible that the voltage to be applied to the LSI ex500 or the apparatus including the LSI ex500 is set higher. When the identification information indicates that the video data conforms to the conventional standard, such as MPEG-2, MPEG-4 AVC, and VC-1, it is possible that the voltage to be applied to the LSI ex500 or the apparatus including the LSI ex500 is set lower. As another example, it is possible that, when the identification information indicates that the video data is generated by the moving picture coding method and the moving picture coding apparatus described in each of embodiments, the driving of the CPU ex502 is not suspended, and when the identification information indicates that the video data conforms to the conventional standard, such as MPEG-2, MPEG-4 AVC, and VC-1, the driving of the CPU ex502 is suspended at a given time because the CPU ex502 has extra processing capacity. It is possible that, even when the identification information indicates that the video data is generated by the moving picture coding method and the moving picture coding apparatus described in each of embodiments, in the case where the CPU ex502 has extra processing capacity, the driving of the CPU ex502 is suspended at a given time. In such a case, it is possible that the suspending time is set shorter than that in the case where when the identification information indicates that the video data conforms to the conventional standard, such as MPEG-2, MPEG-4 AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

### [Exemplary Application E]

There are cases where a plurality of video data that conforms to different standards, is provided to the devices and systems, such as a television and a cellular phone. In order to enable decoding the plurality of video data that conforms to the different standards, the signal processing unit ex507 of the LSI ex500 needs to conform to the different standards. However, the problems of increase in the scale of the circuit of the LSI ex500 and increase in the cost arise with the individual use of the signal processing units ex507 that conform to the respective standards.

In order to solve the problem, what is conceived is a configuration in which the decoding processing unit for implementing the moving picture decoding method described in each of embodiments and the decoding processing unit that conforms to the conventional standard, such as MPEG-2, MPEG-4 AVC, and VC-1 are partly shared. Ex900 in FIG. 128A shows an example of the configuration. For example, the moving picture decoding method described in each of embodiments and the moving picture decoding method that conforms to MPEG-4 AVC have, partly in common, the details of processing, such as entropy coding, inverse quantization, deblocking filtering, and motion compensated prediction. It is possible for a decoding processing unit ex902 that conforms to MPEG-4 AVC to be shared by common processing operations, and for a dedicated decoding processing unit ex901 to be used for processing which is unique to an aspect of the present disclosure and does not conform to MPEG-4 AVC. In particular, since the aspect of the present disclosure is characterized by motion compensation, it is possible, for example, for the dedicated decoding processing unit ex901 to be used for motion compensation, and for the decoding processing unit to be shared by any or all of the other processing, such as entropy decoding, deblocking filtering, and inverse quantization. The decoding processing unit for implementing the moving picture decoding method described in each of embodiments may be shared for the processing to be shared, and a dedicated decoding processing unit may be used for processing unique to that of MPEG-4 AVC.

Furthermore, ex1000 in FIG. 128B shows another example in that processing is partly shared. This example uses a configuration including a dedicated decoding processing unit ex1001 that supports the processing unique to an aspect of the present disclosure, a dedicated decoding processing unit ex1002 that supports the processing unique to another conventional standard, and a decoding processing unit ex1003 that supports processing to be shared between the moving picture decoding method according to the aspect of the present disclosure and the conventional moving picture decoding method. Here, the dedicated decoding processing units ex1001 and ex1002 are not necessarily specialized for the processing according to the aspect of the present disclosure and the processing of the conventional standard, respectively, and may be the ones capable of implementing general processing. Furthermore, the configuration of the present embodiment can be implemented by the LSI ex500.

As such, reducing the scale of the circuit of an LSI and reducing the cost are possible by sharing the decoding processing unit for the processing to be shared between the moving picture decoding method according to the aspect of the present disclosure and the moving picture decoding method in conformity with the conventional standard.

1. A method of encoding video comprising:
writing a maximum size of a picture buffer into a header of a coded video bitstream, wherein a maximum number of pictures allowed in the picture buffer is derived from the maximum size of the picture buffer;
selecting a plurality of pictures having a consecutive output order to be encoded according to a predetermined coding order, wherein (i) the coding order is different from the output order and (ii) the coding order requires one or more non-reference pictures from among the plurality of pictures to be stored in the picture buffer in order to output the plurality of pictures according to the output order;
writing parameters describing a first reference picture set into the coded video bitstream, wherein the number of reference pictures in the first reference picture set is one fewer than the maximum number of pictures allowed in the picture buffer;
encoding a first non-reference picture from among the plurality of pictures into the coded video bitstream using the first reference picture set;
writing parameters describing a second reference picture set into the coded video bitstream, wherein the number of reference pictures in the second reference picture set is one fewer than the number of reference pictures in the first reference picture set; and
encoding a second non-reference picture from among the plurality of pictures into the coded video bitstream using the second reference picture set.

2. The method of encoding video according to claim 1, further comprising
encoding the plurality of pictures according to the coding order, wherein (i) a reference picture set associated with a predetermined picture within the coding order does not include a reference picture previously included in a reference picture set associated with the picture immediately preceding the predetermined picture in the coding order, and (ii) the number of pictures in the reference picture set associated with the predetermined picture is at most two fewer than the maximum number of pictures allowed in the picture buffer.

3. The method of encoding video according to claim 1, further comprising:
encoding a subset of pictures from among the plurality of pictures according to the coding order, wherein reference pictures from among the subset of pictures are stored into the picture buffer until a maximum number of reference pictures allowed in the picture buffer is reached; and
encoding the remaining pictures from among the plurality of pictures according to the coding order, wherein (i) a reference picture set associated with a predetermined picture within the coding order does not include a reference picture previously included in a reference picture set associated with the picture immediately preceding the predetermined picture in the coding order, and (ii) the number of pictures in the reference picture set associated with the predetermined picture is at most two fewer than the maximum number of pictures allowed in the picture buffer.

4. The method of encoding video according to claim 2, wherein the predetermined picture associated with the reference picture set which does not include the previous reference picture occurs once out of every two consecutive pictures within the coding order.

5. The method of encoding video according to claim 1, wherein the coding order includes pictures to be coded as reference pictures and pictures to be coded as non-reference pictures.

6. The method of encoding video according to claim 1, wherein the coding order arranges pictures into hierarchical structures in which pictures having higher hierarchical levels are bi-directionally inter predicted from pictures having lower hierarchical levels.

7. The method of encoding video according to claim 6, wherein selection of the previous reference picture to be excluded from the reference picture set associated with the predetermined picture is based on at least one of hierarchical levels of reference pictures and output order distances between reference pictures to the predetermined picture.

8. A method of decoding video comprising:
parsing a maximum size of a picture buffer from a header of a coded video bitstream, wherein the maximum number of pictures allowed in the picture buffer is derived from the maximum size of the picture buffer;
parsing a first reference picture set from the coded video bitstream, wherein the number of reference pictures in the first reference picture set is one fewer than the maximum number of pictures allowed in the picture buffer;
decoding a first non-reference picture from the coded video bitstream using the first reference picture set;
storing the first non-reference picture in the picture buffer;
parsing a second reference picture set from the coded video bitstream, wherein the number of reference pictures in the second reference picture set is one fewer than the number of reference pictures in the first reference picture set;
decoding a second non-reference picture from the coded video bitstream using the second reference picture set; and
outputting the first non-reference picture at a time instance later than or equal to the time instance at which the decoding of second non-reference picture is completed.

9. The method of decoding video according to claim 8,
wherein (i) a reference picture set associated with a predetermined picture does not include a reference picture previously included in a reference picture set associated with the picture immediately preceding the predetermined picture, and (ii) the number of pictures in the reference picture set associated with the predetermined picture is at most two fewer than the maximum number of pictures allowed in the picture buffer,
wherein the method of decoding video further comprises:
parsing the reference picture set associated with the predetermined picture from the coded video bitstream, and parsing the reference picture set associated with the picture immediately preceding the predetermined picture from the coded video bitstream;
decoding a plurality of pictures from the coded video bitstream using (i) the reference picture set associated with the predetermined picture from the coded video bitstream and (ii) parsing the reference picture set associated with the picture immediately preceding the predetermined picture from the coded video bitstream; and
storing the plurality of pictures in the picture buffer.

10. The method of decoding video according to claim 8,
wherein (i) a reference picture set associated with a predetermined picture does not include a reference picture previously included in a reference picture set associated with the picture immediately preceding the predetermined picture, and (ii) the number of pictures in the reference picture set associated with the predetermined picture is at most two fewer than the maximum number of pictures allowed in the picture buffer, and
wherein the method of decoding video further comprises:
parsing the reference picture set associated with the predetermined picture from the coded video bitstream, and parsing the reference picture set associated with the picture immediately preceding the predetermined picture from the coded video bitstream;
decoding and storing, in the picture buffer, a subset of pictures from among a plurality of pictures from the coded video bitstream using (i) the reference picture set associated with the predetermined picture from the coded video bitstream and (ii) parsing the reference picture set associated with the picture immediately preceding the predetermined picture from the coded video bitstream, until a maximum number of reference pictures allowed in the picture buffer is reached; and
decoding and storing, in the picture buffer, the remaining pictures from among the plurality of pictures from the coded video bitstream using (i) the reference picture set associated with the predetermined picture from the coded video bitstream and (ii) parsing the reference picture set associated with the picture immediately preceding the predetermined picture from the coded video bitstream.

11. The method of decoding video according to claim 9, wherein the predetermined picture associated with the reference picture set which does not include the previous reference picture occurs once out of every two consecutive pictures within the coded video bitstream.

12. The method of decoding video according to claim 8, wherein the coded video bitstream includes pictures to be coded as reference pictures and pictures to be coded as non-reference pictures.

13. The method of decoding video according to claim 8, wherein the coded video bitstream arranges pictures into hierarchical structures in which pictures having higher hierarchical levels are bi-directionally inter predicted from pictures having lower hierarchical levels.

14. The method of decoding video according to claim 13, wherein, during coding of the coded video, selection of the previous reference picture to be excluded from the reference picture set associated with the predetermined picture is based on at least one of hierarchical levels of reference pictures and output order distances between reference pictures to the predetermined picture.
